(19) United States
(12) Patent Application Publication
(10) Pub. No.: US 2025/0175850 A1
(43) Pub. Date: May 29, 2025

(54) RADIO TERMINAL, RADIO ACCESS NETWORK NODE, AND METHODS THEREFOR

(71) Applicant: NEC Corporation, Minato-ku,Tokyo (JP)

(72) Inventor: Satoaki HAYASHI, Tokyo (JP)

(73) Assignee: NEC Corporation, Minato-ku, Tokyo (JP)

(21) Appl. No.: 18/841,772

(22) PCT Filed: Feb. 8, 2023
(86) PCT No.: PCT/JP2023/004119

§ 371 Date: Aug. 27, 2024

(30) Foreign Application Priority Data
Mar. 11, 2022 (JP) 2022-038088

(51) Int. Cl. H04W 28/02; H04B 17/318; H04W 72/25

(52) U.S. Cl. CPC H04W 28/0278; H04B 17/328; H04W 72/25

(57) ABSTRACT

A radio terminal (1A) generates a buffer status report or traffic pattern information, considering a transmission status of transmission on the second sidelink carrier. The radio terminal (1A) transmits the generated buffer status report or traffic pattern information to a radio access network node (2). This helps, for example, to avoid the radio terminal receiving an excessive amount of grant in excess of what is actually needed for transmission on a first sidelink carrier in the case of aggregating the first sidelink carrier to which a first resource allocation mode is applied, in which resources are allocated by a radio access network node, with the second sidelink carrier to which a second resource allocation mode is applied, in which the radio terminal autonomously selects resources.

### TECHNICAL FIELD

The present disclosure relates to direct communication between radio terminals (device-to-device (D2D) communication), in particular to the use of multiple carriers in direct communication.

### BACKGROUND ART

The mode in which a radio terminal communicates directly with another radio terminal, without the need for an infrastructure network such as a base station, is commonly referred to as device-to-device (D2D) communication. D2D communications can be integrated with or assisted by a cellular network. Proximity-based services (ProSe), specified in the Third Generation Partnership Project (3GPP (registered trademark)) Release 12 and beyond, provide a system architecture for D2D communications assisted by a cellular network. In addition, cellular Vehicle-to-Everything (V2X) services, specified in 3GPP Release 14 and beyond, refer to ProSe and use D2D communications between radio terminals. D2D communications assisted by a cellular network can also be used for other applications and services (e.g., public safety applications) in addition to V2X services.

The interface between 3GPP radio terminals (i.e., User Equipments (UEs)) used in the control and user planes for D2D communication is called the PC5 interface (or reference point). D2D communication over the PC5 interface is referred to as sidelink communication. The PC5 interface can be based on the Evolved Universal Terrestrial Radio Access (E-UTRA) sidelink capability and can also be based on the 5G New Radio (NR) sidelink capability. D2D (or sidelink) communication over the E-UTRA-PC5 (or Long Term Evolution (LTE)-based PC5) interface is connectionless, i.e., broadcast mode at the Access Stratum (AS) layer. In contrast, sidelink communication over the NR PC5 interface supports unicast mode, groupcast mode, and broadcast mode at the AS layer.

Sidelink communication over the E-UTRA-PC5 interface is referred to, for example, as LTE sidelink communication. Sidelink communication over the NR PC5 interface is referred to, for example, as NR sidelink communication. The 3GPP specification specifies architectural enhancements to facilitate vehicular communications for cellular V2X services (see, for example, Non-Patent Literature 1, 2, and 3). LTE sidelink and NR sidelink communications play an important role in enabling cellular V2X communications. V2X communication over the E-UTRA-PC5 interface, or AS functionality using E-UTRA technology including LTE sidelink communication to enable V2X communication between UEs is referred to as V2X sidelink communication or LTE V2X sidelink communication. V2X communication over the NR PC5 interface, or AS functionality using NR technology including NR sidelink communication to enable V2X communication between UEs is referred to as NR V2X sidelink communication or simply NR sidelink communication.

3GPP Release 15 supports carrier aggregation (CA) and multicarrier operation for LTE sidelink communications (see Non-Patent Literature 1 and 4). For 3GPP Release 18, the 3GPP plans to discuss Sidelink Evolution. This includes support for carrier aggregation for NR sidelink communications and support for sidelink over unlicensed spectrum (see Non-Patent Literature 5).

Patent Literature 1, 2, and 3 disclose sidelink (SL) carrier aggregation, i.e., carrier aggregation for SL communications, and in particular, signaling between UEs and signaling between a UE and a radio access network (e.g., base station) for SL carrier aggregation.

Patent Literature 1 describes that a UE may send to a peer UE an SL carrier aggregation configuration related to the addition, release or modification of a secondary SL (see, for example, FIGS. 3, 4, 5, and 10 in Patent Literature 1). The SL carrier aggregation configuration may be related to the addition, release, or modification of a secondary SL and may include a set of carrier frequencies and deactivation timer information. The SL carrier aggregation configuration may include a reception (Rx) or transmission (Tx) indicator, a primary or secondary SL indicator, a type of carrier aggregation (e.g., data replication or data split), a V2X service type, a synchronization type, a primary SL index (or carrier index), a secondary SL index (or carrier index), SL Tx or Rx resource allocation information, and so on.

Patent Literature 1 describes that after PC5 carrier aggregation is configured, the UE may notify this to the base station (see, for example, FIG. 6 in Patent Literature 1). The notification message may include at least one of a set of carrier frequency information, a deactivation timer, and a peer UE identifier. For each SL component carrier, the notification message may further include a reception (Rx) or transmission (Tx) indicator, a primary or secondary SL indicator, a type of carrier aggregation (e.g., data replication or data split), a V2X service type, a synchronization type, a primary SL index (or carrier index), a secondary SL index (or carrier index), SL Tx or Rx resource allocation information, and so on.

Patent Literature 1 states that a UE may send a request for SL carrier aggregation configuration between the UE and a peer UE to the base station, and the base station may generate the configuration and provide it to the UE (see, for example, FIG. 9 in Patent Literature 1). Patent Literature 1 also states that the request message is optional and that the base station may provide the SL carrier aggregation configuration to the UE regardless of receipt of the request message from the UE.

Patent Literature 1 describes that UEs may exchange information about their respective SL carrier aggregation capability directly with each other prior to configuring SL carrier aggregation (see, for example, FIG. 13 in Patent Literature 1). The SL carrier aggregation capability includes one or both of the following: SL band combination information, SL and Uu band combination information. Uu is the air interface between the UE and the base station. The band combination information sent by the UE indicates the list of carriers and the bandwidth of each carrier on which the UE can operate simultaneously. The UE may indicate whether it supports both transmit (Tx) and receive (Rx) or only one of transmit (Tx) and receive (Rx) on each carrier.

Patent Literature 2 describes that a UE receives from a wireless wide area network (WAN) a Radio Resource Control (RRC) signal (e.g., RRC Connection Reconfiguration message) containing a command to add or release a component carrier of a V2X carrier aggregation (see, for example, FIGS. 2 and 3 of Patent Literature 2).

Patent Literature 3 describes that a first wireless device receives a sidelink message containing sidelink capability information of a second wireless device from the second wireless device via a sidelink channel and transmits an uplink message containing the sidelink capability information to the base station (see, e.g., FIG. 25 in Patent Literature 3). The sidelink capability information of the second wireless device may indicate whether the second wireless device supports sidelink multiple carrier operation (e.g., sidelink carrier aggregation, sidelink multiple carriers, sidelink multi-carrier), a supported/operating sidelink (e.g., LTE, 5G, etc.), an available band, whether the second wireless device supports an unlicensed band (or unlicensed spectrum), and the like. The base station may determine configuration parameters for sidelink communication between the first and second wireless devices based on the sidelink capability information of the second wireless device, and send those configuration parameters to the first wireless device. The configuration parameters may be sent in an RRC message, a Medium Access Control (MAC) Control Element (CE), or a Physical Downlink Control Channel (PDCCH) transmission (e.g., Downlink Control Information (DCI)).

Patent Literature 3 describes that the first wireless device receives a sidelink message containing band combination information of the second wireless device from the second wireless device via a sidelink channel, and transmits an uplink message (e.g., an RRC message) containing the band combination information to the base station (see, for example, FIG. 26 of Patent Literature 3). The band combination information of the second wireless device may indicate one or more bands that are allowed to be used simultaneously for sidelink communication at the second wireless device. The band combination information of the second wireless device may indicate whether the second wireless device supports multiple sidelink carriers (e.g., multicarrier operation, sidelink carrier aggregation). For example, the base station may determine or assign resources corresponding to multiple carriers if the band combination information indicates that the second wireless device supports multiple sidelink carriers. The base station transmits configuration parameters for sidelink communication between the first and second wireless devices to the first wireless device. The configuration parameters may indicate a sidelink resource assignment. More specifically, the sidelink resource assignment may indicate a first sidelink radio resource in the first carrier and a second sidelink radio resource in the second carrier. The first wireless device may transmit a first transport block to the second wireless device on the first sidelink radio resource and a second transport block to the second wireless device on the second sidelink radio resource.

### CITATION LIST

### Patent Literature

[Patent Literature 1] WO 2019/023857 A1
[Patent Literature 2] US 2019/0246377 A1
[Patent Literature 3] US 2021/0051653 A1

### Non Patent Literature

[Non-Patent Literature 1] 3GPP TR 37.985 V17.0.0 (2021-12) “3rd Generation Partnership Project; Technical Specification Group Radio Access Network; Overall description of Radio Access Network (RAN) aspects for Vehicle-to-everything (V2X) based on LTE and NR (Release 17)”, December 2021
[Non-Patent Literature 2] 3GPP TS 23.287 V17.2.0 (2021-12) “3rd Generation Partnership Project; Technical Specification Group Services and System Aspects; Architecture enhancements for 5G System (5GS) to support Vehicle-to-Everything (V2X) services (Release 17)”, December 2021
[Non-Patent Literature 3] 3GPP TS 24.587 V17.4.1 (2021-12) “3rd Generation Partnership Project; Technical Specification Group Core Network and Terminals; Vehicle-to-Everything (V2X) services in 5G System (5GS); Stage 3 (Release 17)”, December 2021
[Non-Patent Literature 4] Huawei, HiSilicon, “WI summary for V2X phase 2 based on LTE”, RP-180858, 3GPP TSG RAN Meeting #80, San Diego, USA, Jun. 11-14, 2018
[Non-Patent Literature 5] OPPO, LG Electronics, “New WID on NR sidelink evolution”, RP-213678, 3GPP TSG RAN Meeting #94e, Electronic Meeting, Dec. 6-17, 2021

### SUMMARY OF INVENTION

### Technical Problem

The inventor has studied carrier aggregation for D2D communication, including NR sidelink communication, and found various problems. Carrier aggregation on a D2D interface or sidelink interface (e.g., PC5 interface) between radio terminals can also be referred to as multicarrier operation.

One of these problems relates to how to support the case where different resource allocation modes are applied to aggregated multiple sidelink carriers. NR sidelink communication supports two resource allocation modes, namely mode 1 and mode 2. In resource allocation mode 1, a radio access network (e.g., gNB) allocates resources. In contrast, in resource allocation mode 2, a UE autonomously selects resources from a resource pool based on sensing by the UE. The carrier aggregation for LTE sidelink communication specified in 3GPP Release 15 does not define such coexistence of resource allocation modes. The Non-Patent Literature and Patent Literature cited above do not provide a solution for such coexistence of resource allocation modes.

Another one of the problems relates to how a UE coordinates or prioritizes between transmissions on a carrier to which resource allocation mode 1 is applied and transmissions on a carrier to which resource allocation mode 2 is applied. The Non-Patent Literature and Patent Literature cited above do not provide a solution to this problem.

One of the objects that the example embodiments disclosed herein seek to achieve is to provide apparatuses, methods, and programs that contribute to solving at least one of a plurality of problems, including the above-described problems related to carrier aggregation on a D2D interface between radio terminals. It should be noted that this object is only one of the objects to be achieved by the example embodiments disclosed herein. Other objects or problems and novel features will become apparent from the following description and the accompanying drawings.

### Solution to Problem

In a first aspect, a radio terminal includes at least one radio transceiver and at least one processor coupled to the at least one radio transceiver. The at least one processor is configured to use, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources. The at least one processor is configured to generate one or both of a buffer status report and traffic pattern information, considering a transmission status of transmission on the second sidelink carrier. The at least one processor is configured to transmit one or both of the buffer status report and the traffic pattern information to the radio access network node.

In a second aspect, a method performed by a radio terminal includes the steps of:
(a) using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
(b) generating one or both of a buffer status report and traffic pattern information, considering a transmission status of transmission on the second sidelink carrier; and
(c) transmitting one or both of the buffer status report and the traffic pattern information to the radio access network node.

In a third aspect, a radio terminal includes at least one radio transceiver and at least one processor coupled to the at least one radio transceiver. The at least one processor is configured to use, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources. The at least one processor is configured to transmit one or both of a buffer status report and traffic pattern information to a radio access network node. The at least one processor is configured to transmit assistance information to the radio access network node, the assistance information being used by the radio access network node to obtain a transmission status of transmission on the second sidelink carrier.

In a fourth aspect, a method performed by a radio terminal includes the steps of:
(a) using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
(b) transmitting one or both of a buffer status report and traffic pattern information to a radio access network node; and
(c) transmitting assistance information to the radio access network node, the assistance information being used by the radio access network node to obtain a transmission status of transmission on the second sidelink carrier.

In a fifth aspect, a radio access network node includes at least one memory and at least one processor coupled to the at least one memory. The at least one processor is configured to receive from a radio terminal one or both of a buffer status report and traffic pattern information regarding a first sidelink carrier to which a first resource allocation mode is applied in which resources are allocated by the radio access network node. The at least one processor is configured to receive, from the radio terminal, assistance information regarding a second sidelink carrier to which a second resource allocation mode is applied in which the radio terminal autonomously selects resources. The at least one processor is configured to generate one or both of a dynamic grant and a configured grant, considering a transmission status of transmission on the second sidelink carrier obtained based on the assistance information. The at least one processor is configured to transmit one or both of the generated dynamic grant and the generated configured grant to the radio terminal.

In a sixth aspect, a method performed by a radio access network node includes the steps of:
(a) receiving from a radio terminal one or both of a buffer status report and traffic pattern information regarding a first sidelink carrier to which a first resource allocation mode is applied in which resources are allocated by the radio access network node;
(b) receiving, from the radio terminal, assistance information regarding a second sidelink carrier to which a second resource allocation mode is applied in which the radio terminal autonomously selects resources;
(c) generating one or both of a dynamic grant and a configured grant, considering a transmission status of transmission on the second sidelink carrier obtained based on the assistance information; and
(d) transmitting one or both of the generated dynamic grant and the generated configured grant to the radio terminal.

In a seventh aspect, a radio terminal includes at least one radio transceiver and at least one processor coupled to the at least one radio transceiver. The at least one processor is configured to use, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources. The at least one processor is configured to, if there is data to be transmitted and if resources of the second sidelink carrier are also available in a time slot of the first sidelink carrier for which a dynamic grant or a configured grant has been obtained, determine whether to transmit the data on the first sidelink carrier or the second sidelink carrier according to a predetermined rule.

In an eighth aspect, a method performed by a radio terminal includes the steps of:
(a) using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources; and
(b) if there is data to be transmitted and if resources of the second sidelink carrier are also available in a time slot of the first sidelink carrier for which a dynamic grant or a configured grant has been obtained, determining whether to transmit the data on the first sidelink carrier or the second sidelink carrier according to a predetermined rule.

In a ninth aspect, a program includes a set of instructions (software codes) that, when loaded into a computer, cause the computer to perform the method according to the second, fourth, sixth, or eighth aspect described above.

### Advantageous Effects of Invention

According to the aspects described above, it is possible to provide apparatuses, methods and programs that contribute to solving at least one of a plurality of problems related to carrier aggregation on a D2D interface between radio terminals.

### BRIEF DESCRIPTION OF DRAWINGS

FIG. 1 shows an example configuration of a radio communication system according to an example embodiment;

FIG. 2 shows an example configuration of a radio communication system according to an example embodiment;

FIG. 3 shows an AS protocol stack of a control plane for RRC on the PC5 interface;

FIG. 4 shows an AS protocol stack of a control plane for PC5-S on the PC5 interface;

FIG. 5 shows an AS protocol stack of a user plane on the PC5 interface;

FIG. 6 shows an example of the structure of NR sidelink layers 2 and 1 with carrier aggregation configured;

FIG. 7 is a flowchart showing an example of an operation of a UE according to an example embodiment;

FIG. 8 is a flowchart showing an example of an operation of a UE according to an example embodiment;

FIG. 9 is a flowchart showing an example of an operation of a UE according to an example embodiment;

FIG. 10 is a flowchart showing an example of an operation of a RAN node according to an example embodiment;

FIG. 11 is a flowchart showing an example of an operation of a UE according to an example embodiment;

FIG. 12 is a flowchart showing an example of an operation of a RAN node according to an example embodiment;

FIG. 13 is a flowchart showing an example of an operation of a UE according to an example embodiment;

FIG. 14 shows an example of signaling between a UE and a RAN node according to an example embodiment;

FIG. 15 is a block diagram showing an example configuration of a UE according to an example embodiment;

FIG. 16 is a block diagram showing an example configuration of a radio access network node according to an example embodiment; and

FIG. 17 is a block diagram showing an example configuration of a core network node and an application server according to an example embodiment.

### EXAMPLE EMBODIMENT

Specific example embodiments will be described hereinafter in detail with reference to the drawings. The same or corresponding elements are denoted by the same symbols throughout the drawings, and duplicated explanations are omitted as necessary for the sake of clarity.

Each of the example embodiments described below may be used individually, or two or more of the example embodiments may be appropriately combined with one another. These example embodiments include novel features different from each other. Accordingly, these example embodiments contribute to attaining objects or solving problems different from one another and contribute to obtaining advantages different from one another.

The example embodiments presented below are primarily described for the 3GPP 5th generation mobile communication system (5G system). However, these example embodiments can be applied to other radio communication systems that support D2D communication technology similar to 3GPP NR sidelink communication.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

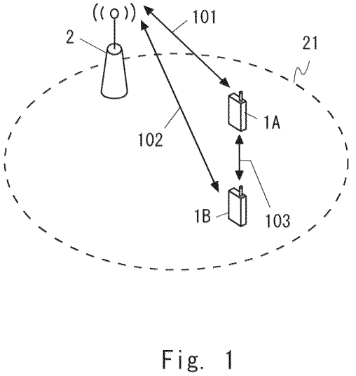

First, the configuration and operation of a plurality of network elements common to a plurality of example embodiments are described. FIG. 1 shows an example configuration of a radio communication system according to a plurality of example embodiments. Each element (or network function) shown in FIG. 1 can be implemented, for example, as a network element on dedicated hardware, as a software instance running on dedicated hardware, or as a virtualized function instantiated on an application platform.

A radio access network (RAN) node (e.g., gNB) 2 manages a cell 21 and is capable of performing cellular communications (101 and 102) with a plurality of radio terminals (UEs) 1, including UEs 1A and 1B, using a cellular communication technology (i.e., NR radio access network). The cellular communication 101 uses an air interface (e.g., Uu interface) between the RAN node 2 and the UE 1A. Similarly, the cellular communication 102 uses an air interface (e.g., Uu interface) between the RAN node 2 and the UE 1B. The example in FIG. 1 shows a situation where the UEs 1A and 1B are located in the same cell 21 for ease of explanation, but such an arrangement is only an example. For example, the UE 1A may be located in one of two adjacent cells managed by different RAN nodes 2, and the UE 1B may be located in the other cell. Alternatively, at least one of the UE 1A and the UE 1B may be located outside the coverage of one or more RAN nodes 2 (i.e., partial coverage, out-of-coverage).

Each of the UEs 1A and 1B has at least one radio transceiver and is configured to perform cellular communication (101 or 102) with the RAN node 2 and to perform D2D communication (i.e., sidelink communication) on a direct inter-UE interface (i.e., NR PC5 interface or NR sidelink) 103. The sidelink communication includes unicast mode communication (sidelink unicast) and may further include one or both of groupcast mode communication and broadcast mode communication.

The interface between 3GPP radio terminals (i.e., UEs) used in the control and user planes for D2D communication is called the PC5 interface (or reference point). D2D communication over the PC5 interface is referred to as sidelink communication. The PC5 interface can be based on the E-UTRA sidelink capability and can also be based on the 5G NR sidelink capability. D2D (or sidelink) communication over the E-UTRA-PC5 (or LTE-based PC5) interface is connectionless, i.e., broadcast mode at the AS layer. In contrast, sidelink communication over the NR PC5 interface supports unicast mode, groupcast mode, and broadcast mode at the AS layer.

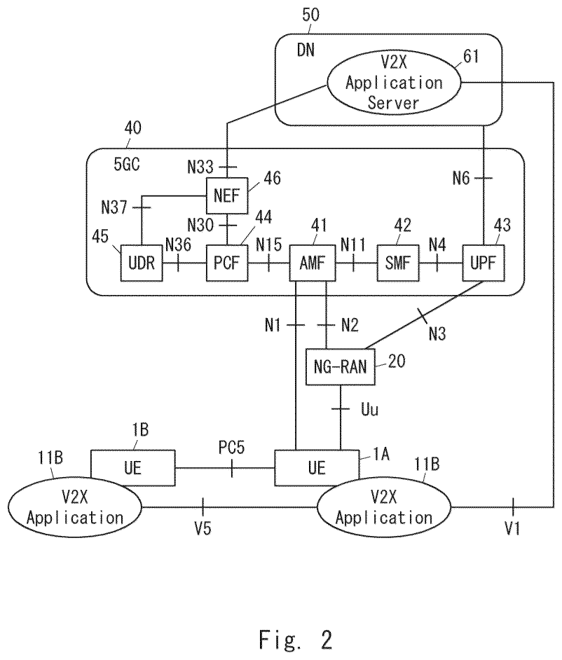

In some implementations, the sidelink communication between the UEs 1A and 1B may be used for cellular V2X services and V2X communication. In other words, the UEs 1A and 1B and the RAN node 2 shown in FIG. 1 may be used in a 5G system providing V2X communications over PC5. FIG. 2 shows an example of a non-roaming 5G system architecture for V2X communication over PC5. Each element (or network function) shown in FIG. 2 can be implemented, for example, as a network element on dedicated hardware, as a software instance running on dedicated hardware, or as a virtualized function instantiated on an application platform. The major reference points (or interfaces) shown in FIG. 2 are described below.

In the following description, when describing matters common to multiple UEs, including the UEs 1A and 1B, it will be referred to simply as UE 1 with the reference sign 1.

The V1 reference point is a reference point between a V2X application (e.g., V2X application 11A or V2X application 11B) in a UE 1 (e.g., UE 1A or UE 1B) and a V2X application in a V2X application server 61. The V2X application server 61 is located in a data network (DN) 50.

The V5 reference point is a reference point between V2X applications of two UEs 1 (e.g., UE 1A and UE 1B). The PC5 reference point is a reference point between UEs (e.g., UE 1A and UE 1B) and includes the NR based PC5. The Uu reference point is a reference point between a UE (e.g., UE 1A) and an NG-RAN 20.

Although not shown in FIG. 2, the UE 1B can also communicate with the NG-RAN 20 via the Uu reference point, as already described.

The N1 reference point is a reference point between a UE 1 (e.g., UE 1A) and an Access and Mobility management Function (AMF) 41 in a 5G Core Network (5GC) 40. The N1 reference point can be used to send V2X policies and parameters from the AMF 41 to the UE 1, and to send the V2X capability and PC5 capability of the UE 1 for V2X communication from the UE 1 to the AMF 41. The N2 reference point is a reference point between the NG-RAN 20 and the AMF 41. The N2 reference point may be used to send V2X policies and parameters from the AMF 41 to the NG-RAN 20. The AMF 41 is one of the network function nodes in the control plane of the 5GC 40. The AMF 41 terminates a single signalling connection (i.e., N1 NAS signalling connection) with the UE 1 (e.g., UE 1A) and provides registration, connection management, and mobility management. The AMF 41 provides network function (NF) services on a service-based interface (i.e., Namf interface) to NF consumers (e.g., Session Management Function (SMF) 42). The NF services provided by the AMF 41 include a communication service (Namf_Communication). The communication service allows an NF consumer (e.g., SMF 42) to communicate with the UE 1 or the NG-RAN 20 through the AMF 41.

The N3 reference point is a reference point between the NG-RAN 20 and a User Plane Function (UPF) 43 in the 5GC. The N6 reference point is a reference point between the UPF 43 and the DN 50. The UPF 43 is one of the network function nodes in the user plane of the 5GC 40. The UPF 43 processes and forwards user data. The functionality of the UPF 43 is controlled by the SMF 42 through the N4 reference point. The UPF 43 may include multiple UPFs connected through N9 reference points. For example, to enable the V2X application 11B in the UE 1A to communicate with the V2X application in the V2X application server 61, the UE 1A uses a path, association, session, or connection through the Uu, N3, and N6 reference points.

The 5G system shown in FIG. 2 may provide Network Exposure Function (NEF) services to enable communication between one or more network functions within the 5GC 40 and the V2X application server 61. A NEF 46 is one of the network function nodes in the control plane of the 5GC 40. The NEF 46 supports the exposure of services and capabilities from the 5G system to application functions and network functions within and outside the operator network. The N33 reference point is a reference point between the NEF 46 and an application function (e.g., V2X application server 61). The NEF 46 provides NF services to NF consumers (e.g., V2X application server 61) on a service-based interface (i.e., Nnef interface). In the case of V2X services, the services provided by the NEF 46 may be used by the V2X application server 61 to update V2X service-related information in the 5GC 40. The NEF 46 may store V2X service-related information in a Unified Data Repository (UDR) 45 either directly through the N37 reference point or through a Policy Control Function (PCF) 44.

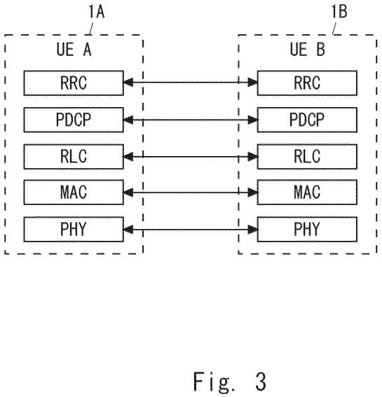

FIGS. 3, 4, and 5 show the AS protocol stacks of the PC5 interface 103. As shown in FIG. 3, the Access Stratum (AS) protocol stack of the control plane for the Sidelink Control Channel (SCCH) for Radio Resource Control (RRC) includes the RRC, Packet Data Convergence Protocol (PDCP), Radio Link Control (RLC), and Medium Access Control (MAC) sublayers and the Physical (PHY) layer. The SCCH is a sidelink logical channel for the transmission of control information (i.e., PC5-RRC and PC5-S messages) from one UE (e.g., UE 1A) to another UE(s) 1 (e.g., UE 1B).

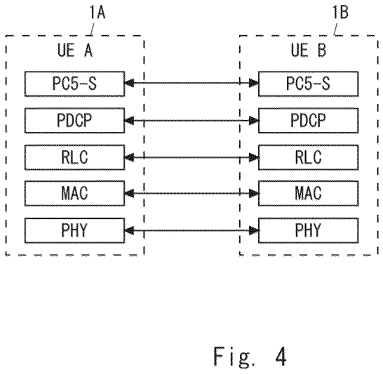

The PC5 interface 103 supports the PC5 Signaling (PC5-S) protocol. As shown in FIG. 4, PC5-S sits on top of the PDCP, RLC, and MAC sublayers and the physical layer in the AS protocol stack of the control plane for SCCH for PC5-S. PC5-S is used for control plane signaling over the PC5 interface 103 for a secure unicast Layer-2 link (or PC5 unicast link). Specifically, PC5-S provides signaling to establish, modify, and release the PC5 unicast link. The PC5 unicast link between the UE 1A and the UE 1B is associated with the Application Layer ID and Layer-2 ID of the UE 1A and the Application Layer ID and Layer-2 ID of the UE 1B. The PC5 unicast link is bidirectional. Therefore, the UE 1A can send application data (e.g., V2X service data, public safety service data) to the UE 1B over the PC5 unicast link with the UE 1B, while the UE 1B can also send application data to the UE 1A over the same PC5 unicast link.

There is a one-to-one correspondence between the PC5 unicast link and the PC5-RRC connection. The PC5-RRC connection is a logical connection between two UEs 1 for a pair of a Source Layer-2 ID and a Destination Layer-2 ID. The PC5-RRC connection is considered to be established after the corresponding PC5 unicast link is established. In other words, the PC5-RRC connection is established in response to the establishment of its corresponding PC5 unicast link. Specifically, when the transmission of a PC5-S message to a specific destination is requested by the upper layers of a sidelink signalling radio bearer (SL SRB), the UE 1 (RRC layer) establishes a PDCP entity, an RLC entity, and an SCCH of the SL SRB for the PC5-S message, based on a predefined SCCH configuration, and then considers a PC5-RRC connection to be established for the destination. Alternatively, when the establishment of a PC5-RRC connection for a specific destination is indicated by the upper layers, the UE 1 (RRC layer) establishes a PDCP entity, an RLC entity, and an SCCH of the SL SRB for PC5-RRC messages for this destination, based on a predefined SCCH configuration, and then considers this PC5-RRC connection to be established.

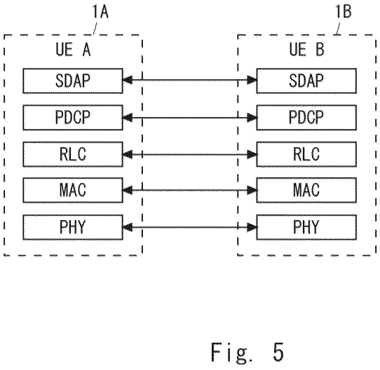

FIG. 5 shows the AS user plane protocol stack for the Sidelink Traffic Channel (STCH). The STCH is a sidelink logical channel for the transmission of user data (e.g., V2X service data, public safety service data) from one UE 1 (e.g., UE 1A) to another UE(s) 1 (e.g., UE 1B). This protocol stack includes the Service Data Adaptation Protocol (SDAP), PDCP, RLC, and MAC sublayers, and the physical layer.

NR sidelink communication on the NR PC5 interface 103 supports two resource allocation modes, i.e., mode 1 and mode 2.

In resource allocation mode 1, the RAN node 2 (e.g., gNB) performs resource allocation. For example, the RAN node 2 allocates or schedules SL radio resources to the UE 1 using the NR Uu interface 101. Resource allocation by mode 1 includes a dynamic grant and a configured grant.

In the case of a dynamic grant, the UE 1 should request resources from the RAN node 2 for the transmission of every single transport block. Specifically, the UE 1 sends a MAC Control Element (CE) (i.e., Sidelink BSR MAC CE) indicating a Sidelink Buffer Status Report (BSR) to the RAN node 2 via an Uplink Shared Channel (UL-SCH) and a Physical Uplink Shared Channel (PUSCH), and the RAN node 2 sends Downlink Control Information (DCI) indicating a dynamic sidelink grant to the UE 1 via a Physical Downlink Control Channel (PDCCH). A dynamic sidelink grant provides allocation of resources for the transmission (and retransmission) of a single transport block. When sidelink carrier aggregation, described below, is configured, a dynamic sidelink grant may provide an allocation of resources for one transport block per sidelink (component) carrier.

In the case of a configured grant, the RAN node 2 allows periodic sidelink resources to the UE 1, which are semi-statically configured by the RRC. Specifically, the UE 1 can send UE assistance information about a sidelink communication traffic pattern to the RAN node 2. Such UE assistance information, or sidelink traffic pattern information sent in UE assistance information, may be referred to as configured grant assistance information. The sidelink traffic pattern information (or configured grant assistance information) may include, for example, the maximum transport block size based on an observed traffic pattern; an estimated timing of packet arrival on a sidelink logical channel; and an estimated data arrival cycle on a sidelink logical channel. The UE 1 sends UE assistance information, including sidelink traffic pattern information, using an RRC message (e.g., UEassistanceinformation message). The RAN node 2 may consider the sidelink traffic pattern information received from the UE 1 and generate a configured grant. The RAN node 2 transmits a configured grant to the UE 1 using an RRC message (e.g., RRCReconfiguration message). A configured grant indicates an allocation of time and frequency resources and the cycle of that resource allocation. There are two types of configured grant for mode 1. In configured grant type 1, a configured grant can be configured or released to the UE 1 by RRC signaling or message (e.g., RRCReconfiguration message) and can be used immediately. In the case of configured grant type 2, the RAN node 2 configures a configured grant to the UE 1 via RRC signaling or message (e.g., RRCReconfiguration message) and activates or deactivates this configured grant via DCI signaling. The UE 1 can only use the periodic resources allocated by the configured grant after it has been activated by the RAN node 2 and only until it is deactivated.

On the other hand, in resource allocation mode 2, the UE 1 autonomously selects resources based on sensing by the UE 1. The sensing is performed in a preconfigured resource pool. If resources are not being used by other UEs for high priority traffic, the UE 1 can select these resources for sidelink transmission and retransmission. The UE 1 is allowed to transmit and retransmit on the selected resources a certain number of times until a resource reselection reason is triggered.

The UEs 1A and 1B support carrier aggregation (CA) on the NR PC5 interface (or NR sidelink) 103. In other words, the UEs 1A and 1B support NR sidelink carrier aggregation, i.e., carrier aggregation for NR sidelink communication. Sidelink carrier aggregation can also be referred to as multicarrier operation. Sidelink carrier aggregation allows the UEs 1A and 1B to communicate with each other on multiple sidelink carriers. Similar to the terminology used for the Uu interface, multiple sidelink carriers used in sidelink carrier aggregation can be referred to as component carriers. In one example, one or more of the multiple sidelink carriers may belong to a licensed spectrum (or licensed band) licensed to the RAN node 2 (or NG-RAN 20) or its operator, while the other one or more may belong to an unlicensed spectrum. The unlicensed spectrum may be ITS spectrum for intelligent transportation systems (ITS).

The UE 1A and the UE 1B support sidelink carrier aggregation in unicast transmissions. The UE 1A and the UE 1B may support sidelink carrier aggregation in groupcast transmissions. The UE 1A and the UE 1B may support sidelink carrier aggregation in broadcast transmissions.

In sidelink carrier aggregation, one or both of the UEs 1A and 1B may not necessarily be able to transmit on multiple sidelink carriers simultaneously. In other words, one or both of the UEs 1A and 1B may not support transmission on multiple sidelink carriers in the same time slot. A UE with such limited transmission capability may be referred to as a limited Tx capability UE. For example, the limited Tx capability may be due to the fact that the number of transmission chains in the UE 1 is less than the number of configured transmit sidelink carriers. Alternatively, the limited Tx capability may be due to the UE 1 not supporting a band combination of configured transmit sidelink carriers. Alternatively, the limited Tx capability may be due to the time required to switch between transmission chains in the UE 1. Alternatively, the limited Tx capability may be due to the inability of the UE 1 to meet radio frequency (RF) requirements such as power spectral density (PSD) imbalance.

Similarly, in sidelink carrier aggregation, one or both of the UEs 1A and 1B may not necessarily be able to receive on multiple sidelink carriers simultaneously. In other words, one or both of the UEs 1A and 1B may not support receiving on multiple sidelink carriers in the same time slot. A UE with such limited receive capabilities may be referred to as a limited Rx capability UE.

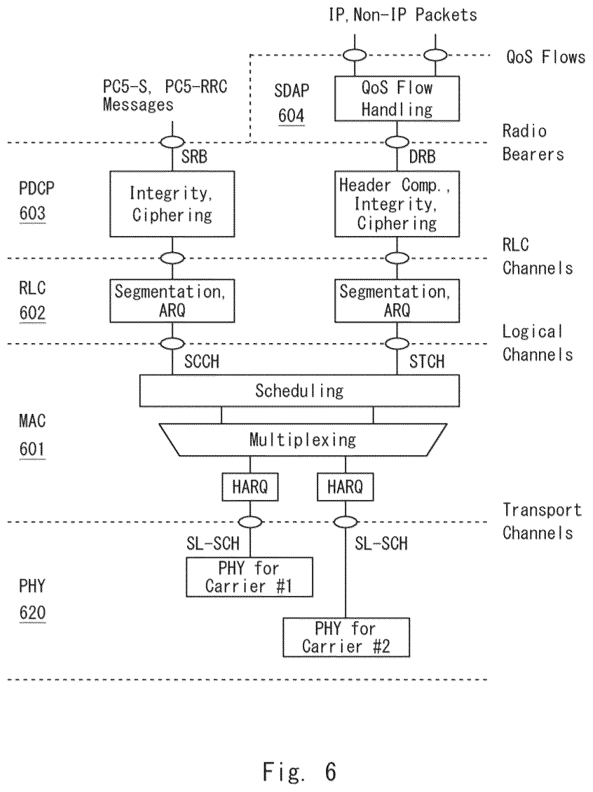

FIG. 6 shows an example of the structure of NR Sidelink Layers 2 and 1 with carrier aggregation configured. Sidelink Layer 2 includes a MAC sublayer 601, an RLC sublayer 602, a PDCP sublayer 603, and an SDAP sublayer 604. In principle, sidelink carrier aggregation is a concept for the MAC sublayer 601 and the physical layer 620 and does not apply to the RLC sublayer 602 and higher layers. However, as discussed below, PC5-RRC messages related to sidelink carrier aggregation may be introduced.

The Physical Layer 620 supports multiple sidelink carriers. If the UE supports transmission on multiple sidelink carriers in the same time slot, the physical layer 620 can transmit a transport block (or MAC Protocol Data Unit (PDU)) on each sidelink carrier in the same time slot. The physical layer 620 offers transport channels to the MAC sublayer 601.

The MAC sublayer 601 provides a single MAC entity for transmission and reception on multiple sidelink carriers. The MAC entity provides a hybrid automatic repeat request (HARQ) entity per sidelink carrier. A single HARQ entity maintains multiple HARQ processes, allowing transmissions to continue on the corresponding sidelink carrier while waiting for HARQ feedback on the success or failure of previous transmissions.

The MAC sublayer 601 offers logical channels to the RLC sublayer 602. The MAC sublayer 601 provides a mapping between logical channels and transport channels, and multiplexes MAC Service Data Units (SDUs) belonging to the same or to different logical channels. Transport channels used in the NR sidelink include a Sidelink Shared Channel (SL-SCH) and a Sidelink Broadcast Channel (SL-BCH). Logical channels used in the NR sidelink include a Sidelink Control Channel (SCCH), a Sidelink Traffic Channel (STCH), and a Sidelink Broadcast Control Channel (SBCCH). SCCH is a control channel and is mapped to SL-SCH. STCH is a traffic channel and is mapped to SL-SCH in a similar way to SCCH. SBCCH is a control channel and is mapped to SL-BCH.

The MAC sublayer 601 provides scheduling for the NR sidelink. This scheduling includes priority handling among multiple logical channels through logical channel prioritization.

If the UE supports transmission on multiple sidelink carriers in the same time slot and has a grant on each of the multiple sidelink carriers, the MAC sublayer provides multiple transport blocks (MAC PDUs) to the physical layer 620 through multiple transport channels (i.e., SL-SCHs), each associated with a respective one of the multiple sidelink carriers, in order to transmit on the multiple sidelink carriers in the same time slot. Each grant may be a dynamic grant or a configured grant in resource allocation mode 1. Alternatively, if the MAC entity is configured with sidelink resource allocation mode 2 to transmit using a resource pool, the MAC entity may generate a sidelink grant selected based on random selection or sensing in the resource pool.

The RLC sublayer 602 offers RLC channels to the PDCP sublayer 603. The RLC sublayer 602 supports three transmission modes, Acknowledged Mode (AM), Unacknowledged Mode (UM), and Transparent Mode (TM). In AM and UM, the RLC sublayer 602 provides segmentation of RLC SDUs. In AM, the RLC sublayer 602 provides ARQ (i.e., retransmission of RLC SDUs or RLC SDU segments).

The PDCP sublayer 603 offers Data Radio Bearers (DRBs) to the SDAP sublayer 604. The PDCP sublayer 603 receives user plane data of DRBs from the SDAP sublayer 604 and provides header compression, integrity protection, and ciphering, for example.

In addition, the PDCP sublayer 603 offers Signalling Radio Bearers (SRBs) to upper layers (i.e., PC5-S layer, PC5-RRC layer). The PDCP sublayer 603 receives control plane data (i.e., PC5-S and PC5-RRC messages) of SRBs from the PC5-S layer and the PC5-RRC layer and provides integrity protection and ciphering, for example.

The SDAP sublayer 604 provides Quality of Service (Qos) flow handling. A QoS flow may be an Internet Protocol (IP) flow, i.e., IP packets. Alternatively, a QoS flow may be a non-IP flow, i.e., non-IP packets. The SDAP sublayer 604 provides a mapping between Qos flows and SL DRBs. There is one SDAP entity per destination for one of unicast, groupcast, and broadcast associated with that destination.

A receiving UE (e.g., UE 1B) performs a Physical Sidelink Feedback Channel (PSFCH) transmission in response to a PSSCH received a few slots earlier. How many slots later a UE that has received a PSSCH transmission in a given slot can transmit HARQ feedback for that PSSCH transmission in a PSFCH symbol depends on the period of the PSFCH symbols, and also on the minimum time gap between the slot with the PSSCH transmission and the slot containing the HARQ feedback. Within a resource block, resources for PSFCH are configured periodically, for example, in cycles of 1, 2, or 4 slots. In other words, within a resource pool, there is a slot with a PSFCH every 1, 2, or 4 slots. In addition, for each resource pool, a minimum number of slots (i.e., minimum time gap) is configured between the slot with the PSSCH transmission and the slot containing the PSFCH for HARQ feedback for that PSSCH transmission. For example, the minimum time gap is 2 or 3.

Specifically, a sidelink resource pool configuration may include PSFCH-related configurations (e.g., SL-PSFCH-Config), including a configuration of the PRBs to be used for PSFCH transmission and reception (e.g., sl-PSFCH-RB-Set), a configuration of the PSFCH period (e.g., sl-PSFCH-Period), and a configuration of the minimum time gap (e.g., sl-MinTimeGapPSFCH). The sidelink resource pool configuration (e.g., SL-BWP-PoolConfigCommon) can be included in a sidelink common configuration (e.g., SL-ConfigCommon) that is broadcast in the system information (e.g., System Information Block 12 (SIB12)). Alternatively, the sidelink resource pool configuration (e.g., SL-BWP-PoolConfig) can be included in a sidelink configuration (e.g., SL-BWP-PoolConfig in sl-ConfigDedicatedNR) that is sent in a UE-specific RRC message (e.g., RRCReconfiguration message). Alternatively, the sidelink resource pool configuration (e.g., SL-BWP-PoolConfigCommon) can be included in a sidelink configuration (e.g., SL-BWP-PoolConfig in SL-PreconfigurationNR) that is preconfigured in the UE.

The receiving UE transmits a PSFCH in the first slot that contains a PSFCH resource and is at least the number of slots later than the last slot of the PSFCH reception as specified in the minimum time gap configuration (e.g., sl-MinTimeGapPSFCH) of the resource pool. Accordingly, if the PSFCH period is four slots, HARQ feedback for PSSCH transmissions in four PSSCH slots can be transmitted in multiple PRBs within a single PSFCH symbol in a single slot.

### First Example Embodiment

This example embodiment provides improvements related to carrier aggregation in the NR sidelink. Specifically, this example embodiment relates to carrier aggregation using a first sidelink carrier to which resource allocation mode 1 applies and a second sidelink carrier to which resource allocation mode 2 applies. The configuration and operation of a radio communication system and network elements (or apparatuses, nodes, devices, or network functions) in this example embodiment may be the same as in the examples described with reference to FIGS. 1 to 6.

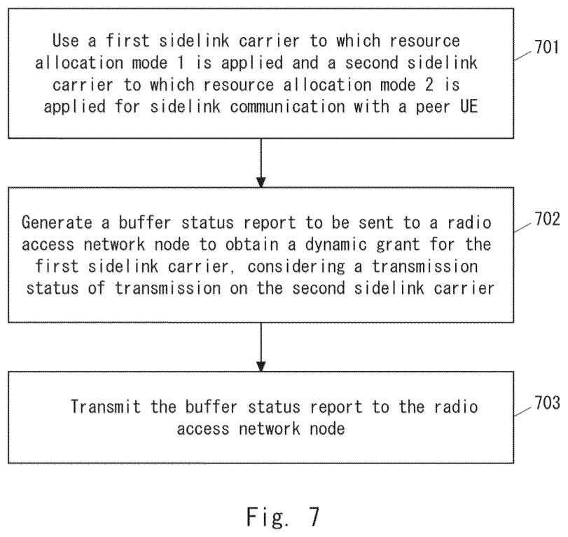

FIG. 7 shows an example of the operation of the UE 1A. In step 701, the UE 1A uses a first sidelink carrier to which resource allocation mode 1 is applied and a second sidelink carrier to which resource allocation mode 2 is applied for sidelink communication with the UE 1B. In the following, the UE 1B is referred to as a peer UE, meaning that the UE 1B is a communication peer or partner of the UE 1A in sidelink communication. The sidelink communication can be unicast. The first sidelink carrier may belong to a licensed spectrum and the second sidelink carrier may belong to an unlicensed spectrum. The unlicensed spectrum can be ITS spectrum.

In step 702, the UE 1A generates a sidelink buffer status report (BSR) (i.e., Sidelink BSR MAC CE) to be sent to the RAN node 2 to obtain a dynamic grant for the first sidelink carrier, considering a transmission status of transmission on the second sidelink carrier. In step 703, the UE 1A transmits the generated sidelink BSR to the RAN node 2. The transmission status of transmission on the second sidelink carrier may be a transmission status estimated by the UE 1A. In other words, the transmission status of transmission on the second sidelink carrier may be a predicted future transmission status.

Specifically, it may be undesirable for the UE 1A to generate a sidelink BSR corresponding to the total volume of data buffered in the UE 1A for transmission to the peer UE 1B. This is because such a sidelink BSR does not take into account a data volume that can be offloaded to the second sidelink carrier, which may result in an excessive dynamic grant. As a result, the resources of the first sidelink carrier may be overused, or the resources of the second sidelink carrier may not be used effectively. To address this issue, instead of generating a sidelink BSR corresponding to the total data volume, the UE 1A may subtract the estimated data volume that can be transmitted on the second sidelink carrier from the total data volume, thereby obtaining a dynamic grant of the appropriate size.

The generation of a sidelink BSR in step 702 may be performed as follows. The UE 1A may estimate the data size, data rate, or traffic pattern of transmission on the second sidelink carrier. The UE 1A may then generate a sidelink BSR to obtain a dynamic grant of transmission on the first sidelink carrier considering the estimated data size, data rate, or traffic pattern.

The UE 1A may generate the sidelink BSR by reducing the total volume of data buffered in the UE 1A for transmission to the peer UE 1B, based on the estimated transmission status (e.g., data size, data rate, or traffic pattern) of the transmission on the second sidelink carrier.

The UE 1A may generate the sidelink BSR by subtracting an estimated volume of data that can be transmitted on the second sidelink carrier from the total volume of data buffered in the radio terminal for transmission to the peer UE 1B.

The UE 1A may generate a sidelink BSR to obtain a dynamic grant for transmission on the first sidelink carrier, taking into account the size (or bandwidth) of a transmission resource pool of the first sidelink carrier and the size (or bandwidth) of a transmission resource pool of the second sidelink carrier. Specifically, the UE 1A may consider the ratio of the size of the transmission resource pool of the first sidelink carrier to the sum of the size of the transmission resource pool of the first sidelink carrier and the size of the transmission resource pool of the second sidelink carrier. For example, the UE 1A may calculate the adjusted or modified total data volume D₂ based on the following equation (1):

$${D}_{2} = {D}_{1} \times \frac{{W}_{1}}{{W}_{1} + {W}_{2}} \qquad ( 1 )$$

where D₁ is the total data volume buffered in the UE 1A for transmission to the peer UE 1B, W₁ is the size of the transmission resource pool of the first sidelink carrier, and W₂ is the size of the transmission resource pool of the second sidelink carrier.

The UE 1A may generate a sidelink BSR to obtain a dynamic grant for transmission on the first sidelink carrier, taking into account a Channel Busy Ratio (CBR) of the first sidelink carrier and a CBR of the second sidelink carrier. The UE 1A may adjust the size W₁ of the transmit resource pool of the first sidelink carrier using the CBR value CBR₁ of the first sidelink carrier. Similarly, the UE 1A may adjust the size W₂ of the transmit resource pool of the second sidelink carrier using the CBR value CBR₂ of the second sidelink carrier. For example, the UE 1A may calculate the adjusted or modified total data volume D₂ based on the following equation (2):

$${D}_{2} = {D}_{1} \times \frac{{W}_{1} ( 1 - {CBR}_{1} )}{{W}_{1} ( 1 - {CBR}_{1} ) + {W}_{2} ( 1 - {CBR}_{2} )} \qquad ( 2 )$$

The UE 1A may generate a sidelink BSR to obtain a dynamic grant for transmission on the first sidelink carrier, taking into account a Sidelink Reference Signal Received Power (SL-RSRP) of the first sidelink carrier and an SL-RSRP of the second sidelink carrier. SL-RSRP measurements of multiple candidate carrier frequencies may be performed by the UE 1 itself. Alternatively, the UE 1 may receive SL-RSRP measurement results from one or more other UEs. The UE 1A may adjust the size W₁ of the transmission resource pool of the first sidelink carrier using the Modulation and Coding Scheme (MCS) value MCS₁ of the first sidelink carrier. Similarly, the UE 1A may adjust the size W₂ of the transmit resource pool of the second sidelink carrier using the MCS value MCS₂ of the second sidelink carrier. For example, the UE 1A may calculate the adjusted or modified total data volume D₂ based on the following equation (3):

$${D}_{2} = {D}_{1} \times \frac{{W}_{1} \times {MCS}_{1}}{{W}_{1} \times {MCS}_{1} + {W}_{2} \times {MCS}_{2}} \qquad ( 3 )$$

The operation of the UE 1 described with reference to FIG. 7 allows the UE 1 to consider the transmission on the second sidelink carrier to which resource allocation mode 2 is applied to generate a sidelink BSR to obtain a dynamic grant for the transmission on the first sidelink carrier to which resource allocation mode 1 is applied. This helps, for example, to avoid the UE 1 receiving an excessive amount of dynamic grant in excess of what is actually required for the transmission on the first sidelink carrier.

### Second Example Embodiment

This example embodiment provides improvements related to carrier aggregation in the NR sidelink. Specifically, this example embodiment relates to carrier aggregation using a first sidelink carrier to which resource allocation mode 1 applies and a second sidelink carrier to which resource allocation mode 2 applies. The configuration and operation of a radio communication system and network elements (or apparatuses, nodes, devices, or network functions) in this example embodiment may be the same as in the examples described with reference to FIGS. 1 to 6.

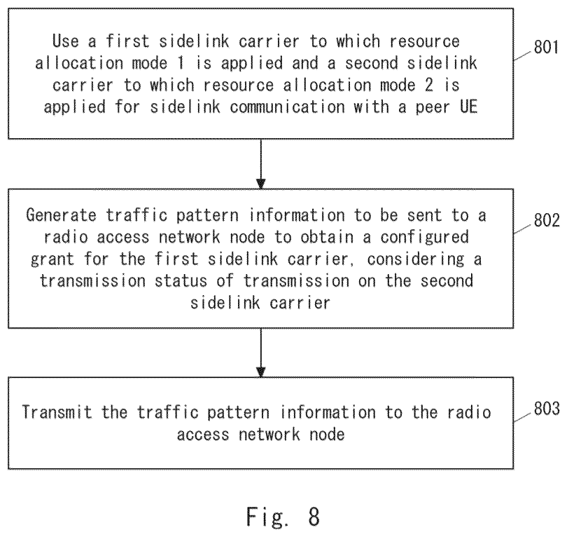

FIG. 8 shows an example of the operation of the UE 1A. The operation shown in FIG. 8 is somewhat similar to that shown in FIG. 7. However, FIG. 7 concerns the transmission of a sidelink BSR to obtain a dynamic grant, whereas FIG. 8 concerns the transmission of sidelink traffic pattern information to obtain a configured grant.

Step 801 in FIG. 8 is the same as step 701 in FIG. 7. Specifically, the UE 1A uses a first sidelink carrier to which resource allocation mode 1 is applied and a second sidelink carrier to which resource allocation mode 2 is applied for sidelink communication with the peer UE 1B. The sidelink communication can be unicast. The first sidelink carrier may belong to a licensed spectrum and the second sidelink carrier may belong to an unlicensed spectrum. The unlicensed spectrum can be ITS spectrum.

In step 802, the UE 1A generates sidelink traffic pattern information to be sent to the RAN node 2 to obtain a configured grant for the first sidelink carrier, considering a transmission status of transmission on the second sidelink carrier. The sidelink traffic pattern information may be referred to as configured grant assistance information. The sidelink traffic pattern information may indicate a maximum transport block size based on an observed traffic pattern. Additionally or alternatively, the sidelink traffic pattern information may indicate an estimated timing of packet arrival on a sidelink logical channel. Additionally or alternatively, the sidelink traffic pattern information may indicate an estimated data arrival periodicity on a sidelink logical channel. In step 803, the UE 1A sends UE assistance information, including the generated sidelink traffic pattern information, to the RAN node 2 using an RRC message. The RRC message may be a UEassistanceinformation message.

Specifically, when obtaining a configured grant for the first sidelink carrier, it may be desirable for the UE 1A to generate sidelink traffic pattern information by excluding traffic that can be transmitted periodically on the second sidelink carrier. This helps to avoid the UE 1A receiving an excessive amount of configured grant.

The generation of sidelink traffic pattern information in step 802 may be performed as follows. The UE 1A may estimate the data size, data rate, or traffic pattern of transmission on the second sidelink carrier. The UE 1A may then generate sidelink traffic pattern information to obtain a configured grant of transmission on the first sidelink carrier considering the estimated data size, data rate, or traffic pattern.

The UE 1A may generate the sidelink traffic pattern information in a manner that indicates an estimated traffic pattern of transmission on the first sidelink carrier, except for an estimated traffic pattern of transmission on the second sidelink carrier.

The operation of the UE 1 described with reference to FIG. 8 allows the UE 1 to consider the transmission on the second sidelink carrier to generate sidelink traffic pattern information to obtain a configured grant for the transmission on the first sidelink carrier. This helps, for example, to avoid the UE 1 receiving an excessive amount of configured grant in excess of what is actually required for the transmission on the first sidelink carrier.

### Third Example Embodiment

This example embodiment provides improvements related to carrier aggregation in the NR sidelink. Specifically, this example embodiment relates to carrier aggregation using a first sidelink carrier to which resource allocation mode 1 applies and a second sidelink carrier to which resource allocation mode 2 applies. The configuration and operation of a radio communication system and network elements (or apparatuses, nodes, devices, or network functions) in this example embodiment may be the same as in the examples described with reference to FIGS. 1 to 6.

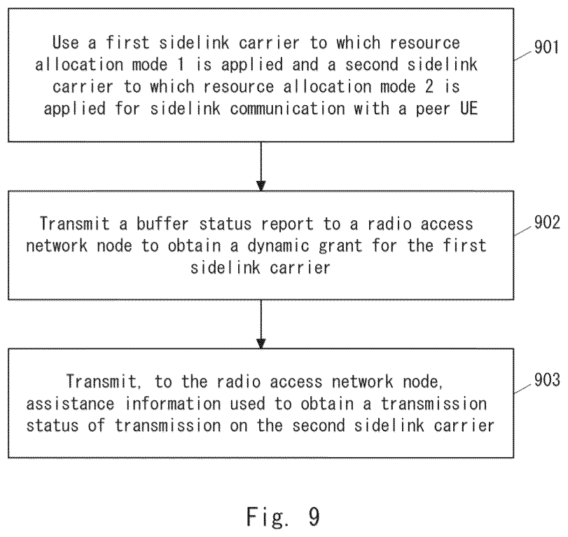

FIG. 9 shows an example of the operation of the UE 1A. The operation shown in FIG. 8 is somewhat similar to that shown in FIG. 7. However, FIG. 9 differs from FIG. 7 in that FIG. 7 concerns the generation of an adjusted or modified sidelink BSR by the UE 1A, whereas FIG. 9 concerns the transmission of assistance information to assist the RAN node 2 in estimating the transmission status of transmission on the second sidelink carrier.

Step 901 is the same as step 701 in FIG. 7. Specifically, the UE 1A uses a first sidelink carrier to which resource allocation mode 1 is applied and a second sidelink carrier to which resource allocation mode 2 is applied for sidelink communication with the peer UE 1B. The sidelink communication can be unicast. The first sidelink carrier may belong to a licensed spectrum and the second sidelink carrier may belong to an unlicensed spectrum. The unlicensed spectrum can be ITS spectrum.

In step 902, the UE 1A transmits a sidelink BSR (i.e., Sidelink BSR MAC CE) to the RAN node 2 to obtain a dynamic grant of the first sidelink carrier. The UE 1 may generate a sidelink BSR corresponding to the total volume of data buffered in the UE 1A for transmission to the peer UE 1B.

In step 903, the UE 1A transmits assistance information to the RAN node 2, which is used to obtain a transmission status of transmission on the second sidelink carrier. The order of the transmission in step 902 and the transmission in step 903 shown in FIG. 9 is an example and is not limited thereto. The assistance information in step 903 may be transmitted before, simultaneously with, or after the sidelink BSR in step 902. The assistance information in step 903 may be transmitted using an RRC message or a MAC CE. This RRC message may be a MeasurementReport message, a UEassistanceinformation message, or a SIdelinkUEinformationNR message.

The assistance information of step 903 may indicate the size (or bandwidth) of a transmission resource pool of the second sidelink carrier. Additionally or alternatively, the assistance information may indicate one or any combination of a CBR, an SL-RSRP, and Sidelink Channel State Information (SL-CSI) of the second sidelink carrier.

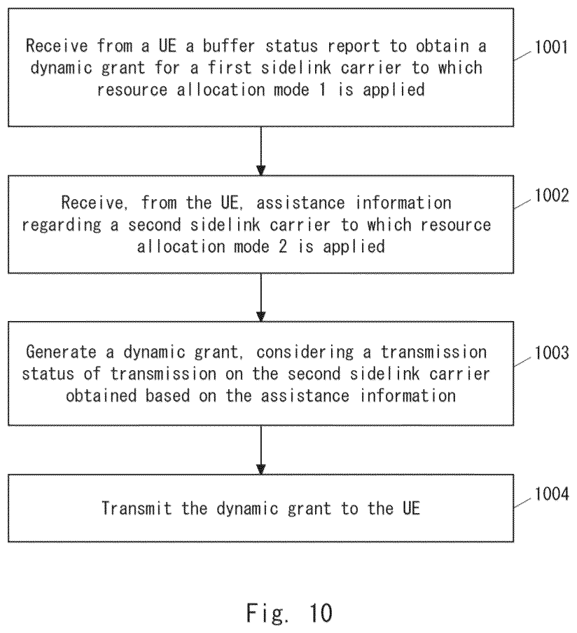

FIG. 10 shows an example of the operation of the RAN node 2. In step 1001, the RAN node 2 receives from the UE 1A a sidelink BSR (i.e., Sidelink BSR MAC CE) seeking to obtain a dynamic grant for the first sidelink carrier to which resource allocation mode 1 is applied.

In step 1002, the RAN node 2 receives, from the UE 1A, assistance information regarding the second sidelink carrier to which resource allocation mode 2 is applied. The order of receiving in step 1001 and receiving in step 1002 shown in FIG. 10 is an example and is not limited thereto. The assistance information of step 1002 may be received before, simultaneously with, or after the sidelink BSR of step 1001. The assistance information in step 1002 may be transmitted using an RRC message or a MAC CE. This RRC message may be a MeasurementReport message, a UEassistanceinformation message, or a SIdelinkUEinformationNR message.

The assistance information of step 1002 may indicate the size (or bandwidth) of a transmission resource pool of the second sidelink carrier. Additionally or alternatively, the assistance information may indicate one or any combination of a CBR, an SL-RSRP, and an SL-CSI of the second sidelink carrier.

In step 1003, the RAN node 2 generates a dynamic grant, considering a transmission status of transmission on the second sidelink carrier obtained based on the assistance information. In step 1004, the RAN node 2 transmits the generated dynamic grant to the UE 1A. The transmission status of transmission on the second sidelink carrier may be a transmission status estimated by the RAN node 2 based on the assistance information. In other words, the transmission status of transmission on the second sidelink carrier may be a predicted future transmission status.

The RAN node 2 may consider an estimated transmission status of transmission on the second sidelink carrier, similar to the operation of the UE 1A described with reference to FIG. 7. Specifically, instead of generating a dynamic grant based directly on the sidelink BSR, the RAN node 2 may subtract an estimated volume of data that can be transmitted on the second sidelink carrier from the total volume of data, thereby generating a dynamic grant of the appropriate size.

The generation of a dynamic grant in step 1003 may be performed as follows. The RAN node 2 may estimate the data size, data rate, or traffic pattern of transmission on the second sidelink carrier. The RAN node 2 may then generate a dynamic grant for a transmission of the first sidelink carrier, taking into account the estimated data size, data rate, or traffic pattern.

The RAN node 2 may generate the dynamic grant by reducing the total volume of data indicated by the sidelink BSR based on the estimated transmission status (e.g., data size, data rate, or traffic pattern) of the transmission on the second sidelink carrier.

The RAN node 2 may generate the dynamic grant by subtracting an estimated volume of data that can be transmitted on the second sidelink carrier from the total volume of data indicated by the sidelink BSR.

The method for adjusting or modifying the total data volume indicated by the sidelink BSR may be the same as any of the examples described in the first example embodiment.

According to the operation of the UE 1 and the RAN node 2 described with reference to FIGS. 9 and 10, the RAN node 2 can generate a dynamic grant for a transmission on the first sidelink carrier, taking into account the transmission on the second sidelink carrier. This helps, for example, to avoid the UE 1 receiving an excessive amount of dynamic grant in excess of what is actually required for the transmission on the first sidelink carrier.

### Fourth Example Embodiment

This example embodiment provides improvements related to carrier aggregation in the NR sidelink. Specifically, this example embodiment relates to carrier aggregation using a first sidelink carrier to which resource allocation mode 1 applies and a second sidelink carrier to which resource allocation mode 2 applies. The configuration and operation of a radio communication system and network elements (or apparatuses, nodes, devices, or network functions) in this example embodiment may be the same as in the examples described with reference to FIGS. 1 to 6.

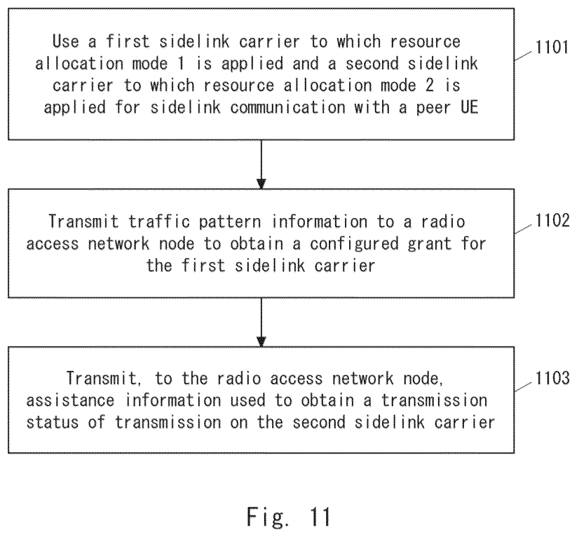

FIG. 11 shows an example of the operation of the UE 1A. The operation shown in FIG. 11 is somewhat similar to that shown in FIG. 9. However, FIG. 9 concerns the transmission of a sidelink BSR to obtain a dynamic grant, whereas FIG. 11 concerns the transmission of sidelink traffic pattern information to obtain a configured grant.

Step 1101 in FIG. 11 is the same as step 901 in FIG. 9. Specifically, the UE 1A uses a first sidelink carrier to which resource allocation mode 1 is applied and a second sidelink carrier to which resource allocation mode 2 is applied for sidelink communication with the peer UE 1B. The sidelink communication can be unicast. The first sidelink carrier may belong to a licensed spectrum and the second sidelink carrier may belong to an unlicensed spectrum. The unlicensed spectrum can be ITS spectrum.

In step 1101, the UE 1A transmits sidelink traffic pattern information to the RAN node 2 to obtain a configured grant for the first sidelink carrier. Specifically, the UE 1A transmits UE assistance information, including the sidelink traffic pattern information, to the RAN node 2 using an RRC message. The RRC message may be a UEassistanceinformation message. The sidelink traffic pattern information may be referred to as configured grant assistance information. The sidelink traffic pattern information may indicate a maximum transport block size based on an observed traffic pattern. Additionally or alternatively, the sidelink traffic pattern information may indicate an estimated timing of packet arrival on a sidelink logical channel. Additionally or alternatively, the sidelink traffic pattern information may indicate an estimated data arrival periodicity on a sidelink logical channel.

In step 1103, the UE 1A transmits assistance information to the RAN node 2, which is used to obtain a transmission status of transmission on the second sidelink carrier. The order of the transmission in step 1102 and the transmission in step 1103 shown in FIG. 11 is an example and is not limited thereto. The assistance information in step 1103 may be transmitted before, simultaneously with, or after the sidelink traffic pattern information in step 1102. The assistance information in step 1103 may be transmitted using an RRC message or a MAC CE. This RRC message may be a MeasurementReport message, a UEassistanceinformation message, or a SIdelinkUEinformationNR message.

The assistance information of step 1103 may indicate the size (or bandwidth) of a transmission resource pool of the second sidelink carrier. Additionally or alternatively, the assistance information may indicate one or any combination of a CBR, an SL-RSR, and an SL-CSI of the second sidelink carrier.

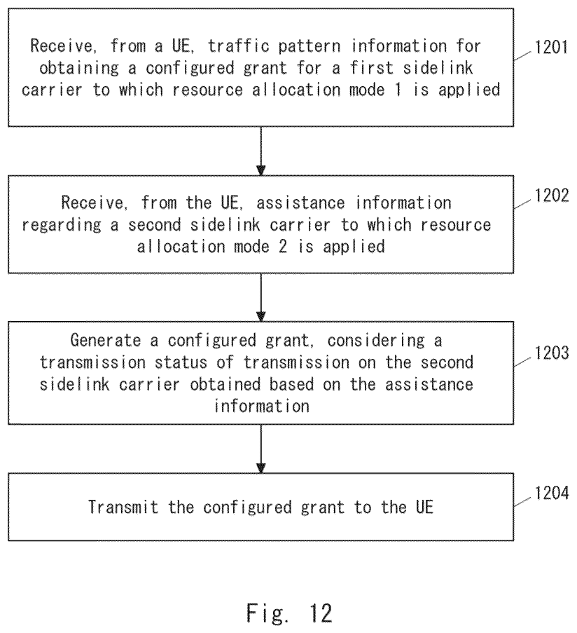

FIG. 12 shows an example of the operation of the RAN node 2. The operation shown in FIG. 12 is somewhat similar to that shown in FIG. 10. However, FIG. 10 concerns the generation of a dynamic grant, whereas FIG. 12 concerns the generation of a configured grant.

In step 1201, the RAN node 2 receives, from the UE 1A, sidelink traffic pattern information for obtaining a configured grant for the first sidelink carrier. Specifically, the RAN node 2 receives UE assistance information, including the sidelink traffic pattern information, via an RRC message. The RRC message may be a UEassistanceinformation message.

In step 1202, the RAN node 2 receives, from the UE 1A, assistance information regarding the second sidelink carrier to which resource allocation mode 2 is applied. The order of receiving in step 1201 and receiving in step 1202 shown in FIG. 12 is an example and is not limited thereto. The assistance information of step 1202 may be received before, simultaneously with, or after the sidelink traffic pattern information of step 1201. The assistance information in step 1202 may be transmitted using an RRC message or a MAC CE. This RRC message may be a MeasurementReport message, a UEassistanceinformation message, or a SIdelinkUEinformationNR message.

The assistance information of step 1202 may indicate the size (or bandwidth) of a transmission resource pool of the second sidelink carrier. Additionally or alternatively, the assistance information may indicate one or any combination of a CBR, an SL-RSRP, and an SL-CSI of the second sidelink carrier.

In step 1203, the RAN node 2 generates a configured grant, considering a transmission status of transmission on the second sidelink carrier obtained based on the assistance information. In step 1204, the RAN node 2 transmits the generated configured grant to the UE 1A.

The RAN node 2 may consider an (estimated) transmission status of transmission on the second sidelink carrier, similar to the operation of the UE 1A described with reference to FIG. 8. Specifically, the RAN node 2 may generate a configured grant by removing an estimated traffic pattern of transmission on the second sidelink carrier from the traffic pattern indicated in the sidelink traffic pattern information.

According to the operation of the UE 1 and the RAN node 2 described with reference to FIGS. 11 and 12, the RAN node 2 can generate a configured grant for transmission on the first sidelink carrier, taking into account the transmission on the second sidelink carrier. This helps, for example, to avoid the UE 1 receiving an excessive amount of configured grant in excess of what is actually required for the transmission on the first sidelink carrier.

### Fifth Example Embodiment

This example embodiment provides improvements related to carrier aggregation in the NR sidelink. Specifically, this example embodiment relates to carrier aggregation using a first sidelink carrier to which resource allocation mode 1 applies and a second sidelink carrier to which resource allocation mode 2 applies. The configuration and operation of a radio communication system and network elements (or apparatuses, nodes, devices, or network functions) in this example embodiment may be the same as in the examples described with reference to FIGS. 1 to 6.

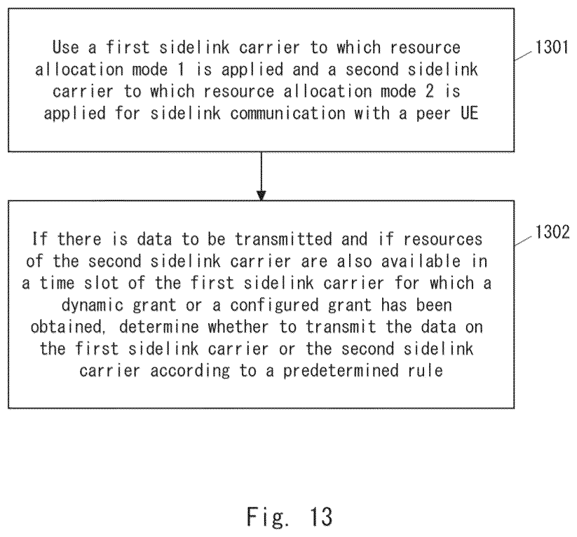

FIG. 13 shows an example of the operation of the UE 1A. The operation of FIG. 13 relates to the coordination or prioritization between transmission on the first sidelink carrier, to which resource allocation mode 1 is applied, and transmission on the second sidelink carrier, to which resource allocation mode 2 is applied.

In step 1301, the UE 1A uses the first sidelink carrier, to which resource allocation mode 1 is applied, and the second sidelink carrier, to which resource allocation mode 2 is applied, for sidelink communication with the peer UE 1B. The sidelink communication can be unicast. The first sidelink carrier may belong to a licensed spectrum and the second sidelink carrier may belong to an unlicensed spectrum. The unlicensed spectrum can be ITS spectrum.

In step 1302, if there is data to be transmitted and if resources of the second sidelink carrier are also available in a time slot of the first sidelink carrier for which a dynamic grant or a configured grant has been obtained, the UE 1A determines whether to transmit the data on the first sidelink carrier or the second sidelink carrier according to a predetermined rule. This process may be performed by the MAC sublayer 601 (or MAC entity) of the UE 1A.

The predetermined rule may be referred to as, for example, a coordination rule, a coordination policy, a prioritization rule, a prioritization policy, a carrier selection rule, or a carrier selection policy.

The UE 1A may be preconfigured with the predetermined rule or with one or more parameters to define the predetermined rule. The UE 1A may store the predetermined rule or one or more parameters for defining the predetermined rule in a non-volatile memory of its Mobile Equipment (ME) or in its Universal Subscriber Identity Module (USIM). The UE 1A may receive the predetermined rule or one or more parameters for defining the predetermined rule from a core network node (e.g., AMF 41, PCF 44) via the N1 reference point between the AMF 41 and the UE 1. Alternatively, the UE 1A may receive them from the V2X application server 61 via the V1 reference point between the UE 1 and the V2X application server 61.

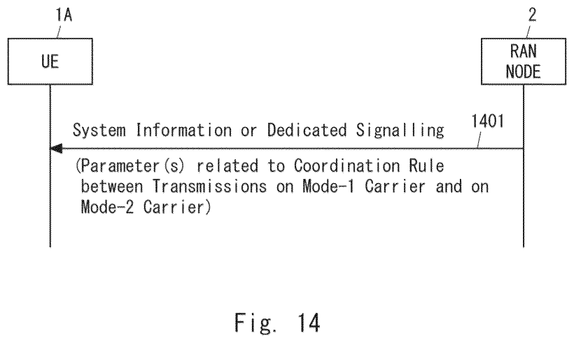

As shown in FIG. 14, the UE 1A may receive a signaling from the RAN node 2 indicating the predetermined rule or one or more parameters for defining the predetermined rule (step 1401). This signaling may be a non-UE specific signaling (e.g., system information broadcast) or a UE specific signaling (e.g., RRC signaling).

Examples of determining based on the predetermined rule in step 1302 are described below. The examples shown below may be combined, as necessary.

The first example relates to the case where the radio transceiver of the UE 1A is capable of transmitting simultaneously on the first and second sidelink carriers in the time domain. In other words, the first example relates to the case where the UE 1A does not have a limited Tx capability. This is also the case for the second to sixth examples below. In the first example, the predetermined rule includes preferentially transmitting the data on the first sidelink carrier. That is, the UE 1A preferentially transmits the data on the first sidelink carrier.

The second example is a variation of the first example. In the second example, the predetermined rule includes, if there is excess data that cannot be included in a first transport block to be transmitted on the first sidelink carrier in the time slot based on the dynamic grant or the configured grant, including the excess data in a second transport block to be transmitted on the second sidelink carrier. That is, if there is excess data that cannot be included in a first transport block to be transmitted on the first sidelink carrier in the time slot based on the dynamic grant or the configured grant, the UE 1A (MAC sublayer 601 or MAC entity) includes the excess data in a second transport block to be transmitted on the second sidelink carrier.

The third example relates to the case where the radio transceiver of the UE 1A is capable of transmitting simultaneously on the first and second sidelink carriers in the time domain. In the third example, the predetermined rule includes, if the difference between a CBR of the first sidelink carrier and a CBR of the second sidelink carrier exceeds a threshold value, selecting one of the two carriers having the lower CBR, otherwise selecting both of the two carriers. That is, if the difference between a CBR of the first sidelink carrier and a CBR of the second sidelink carrier exceeds a threshold value, the UE 1A selects one of the two carriers having the lower CBR, otherwise it selects both of the two carriers.

The fourth example relates to the case where the radio transceiver of the UE 1A is capable of transmitting simultaneously on the first and second sidelink carriers in the time domain. In the fourth example, the predetermined rule includes, if the difference between an SL-RSRP of the first sidelink carrier and an SL-RSRP of the second sidelink carrier exceeds a threshold value, selecting one of the two carriers having the better SL-RSRP, otherwise selecting both of the two carriers. That is, if the difference between an SL-RSRP of the first sidelink carrier and an SL-RSRP of the second sidelink carrier exceeds a threshold value, the UE 1A selects one of the two carriers having the better SL-RSRP, otherwise it selects both of the two carriers.

The fifth example relates to the case where the radio transceiver of the UE 1A is capable of transmitting simultaneously on the first and second sidelink carriers in the time domain. In the fifth example, the predetermined rule includes selecting one or both of one of the first and second sidelink carriers whose CBR is lower than a threshold value. That is, the UE 1A selects one or both of one of the first and second sidelink carriers whose CBR is lower than a threshold value.

The sixth example relates to the case where the radio transceiver of the UE 1A is capable of transmitting simultaneously on the first and second sidelink carriers in the time domain. In the sixth example, the predetermined rule includes selecting one or both of one of the first and second sidelink carriers whose SL-RSRP is better than a threshold value. That is, if the UE 1A is capable of transmitting simultaneously on the first sidelink carrier and the second sidelink carrier in the time domain, the UE 1A selects one or both of one of the first and second sidelink carriers whose SL-RSRP is better than a threshold value.

The seventh example relates to the case where the radio transceiver of the UE 1A is unable to transmit simultaneously on the first and second sidelink carriers in the time domain. In other words, the seventh example relates to the case where the UE 1A has limited Tx capability. This is also the case for the eighth to eleventh examples below. In the seventh example, the predetermined rule includes preferentially transmitting the data on the first sidelink carrier. That is, the UE 1A preferentially transmits the data on the first sidelink carrier.

The eighth example relates to the case where the radio transceiver of the UE 1A is unable to transmit simultaneously on the first and second sidelink carriers in the time domain. In the eighth example, the predetermined rule includes selecting the second sidelink carrier when a CBR of the second sidelink carrier is lower than a CBR of the first sidelink carrier by more than a threshold value, otherwise selecting the first sidelink carrier. That is, the UE 1A selects the second sidelink carrier when a CBR of the second sidelink carrier is lower than a CBR of the first sidelink carrier by more than a threshold value, otherwise it selects the first sidelink carrier.

The ninth example relates to the case where the radio transceiver of the UE 1A is unable to transmit simultaneously on the first and second sidelink carriers in the time domain. In the ninth example, the predetermined rule includes selecting the second sidelink carrier when an SL-RSRP of the second sidelink carrier is better than an SL-RSRP of the first sidelink carrier by more than a threshold value, otherwise selecting the first sidelink carrier. That is, the UE 1A selects the second sidelink carrier when an SL-RSRP of the second sidelink carrier is better than an SL-RSRP of the first sidelink carrier by more than a threshold value, otherwise it selects the first sidelink carrier.

The tenth example relates to the case where the radio transceiver of the UE 1A is unable to transmit simultaneously on the first and second sidelink carriers in the time domain. In the tenth example, the predetermined rule includes selecting one of the first and second sidelink carriers whose CBR is lower than that of the other. That is, the UE 1A selects one of the first and second sidelink carriers whose CBR is lower than that of the other.

The eleventh example relates to the case where the radio transceiver of the UE 1A is unable to transmit simultaneously on the first and second sidelink carriers in the time domain. In the eleventh example, the predetermined rule includes selecting one of the first and second sidelink carriers whose SL-RSRP is better than that of the other. That is, the UE 1A selects one of the first and second sidelink carriers whose SL-RSRP is better than that of the other.

The operation of the UE 1 described in this example embodiment allows the UE 1 to coordinate or prioritize between transmissions on a carrier to which resource allocation mode 1 applies and transmissions on a carrier to which resource allocation mode 2 applies.

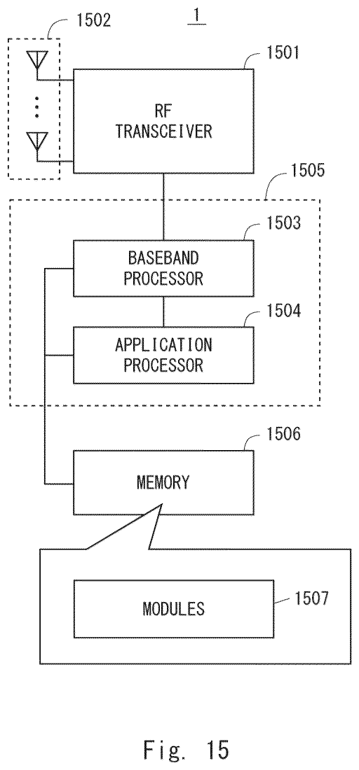

Examples of configurations of the UE 1, the RAN node 2, core network nodes such as the AMF 41, and the V2X application server 61 according to the plurality of example embodiments described above are provided below. FIG. 15 is a block diagram showing an example configuration of the UE 1. A radio frequency (RF) transceiver 1501 performs analog RF signal processing to communicate with other UEs and the RAN node 2. The RF transceiver 1501 may include a plurality of transceivers. The analog RF signal processing performed by the RF transceiver 1501 includes frequency up-conversion, frequency down-conversion, and amplification. The RF transceiver 1501 is coupled to an antenna array 1502 and a baseband processor 1503. The RF transceiver 1501 receives modulated symbol data (or OFDM symbol data) from the baseband processor 1503, generates a transmission RF signal, and supplies the transmission RF signal to the antenna array 1502. The RF transceiver 1501 generates a baseband reception signal based on a reception RF signal received by the antenna array 1502 and supplies the baseband reception signal to the baseband processor 1503. The RF transceiver 1501 may include an analog beamformer circuit for beamforming. The analog beamformer circuit includes, for example, a plurality of phase shifters and a plurality of power amplifiers.

The baseband processor 1503 performs digital baseband signal processing (data-plane processing) and control-plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) Inverse Fast Fourier Transform (IFFT) generation of OFDM symbol data (baseband OFDM signal). On the other hand, the control-plane processing includes communication management of layer 1 (e.g., transmission power control), layer 2 (e.g., radio resource management, and hybrid automatic repeat request (HARQ) processing), and layer 3 (e.g., signaling regarding attach, mobility, and call management).

For example, the digital baseband signal processing performed by the baseband processor 1503 may include signal processing in the Service Data Adaptation Protocol (SDAP) layer, Packet Data Convergence Protocol (PDCP) layer, Radio Link Control (RLC) layer, Medium Access Control (MAC) layer, and Physical (PHY) layer. The control-plane processing performed by the baseband processor 1503 may include processing of Non-Access Stratum (NAS) protocols, Radio Resource Control (RRC) protocols, MAC Control Elements (CEs), and Downlink Control Information (DCIs). The control-plane processing may include processing of PC5-S signaling and PC5-RRC signaling.

The baseband processor 1503 may perform Multiple Input Multiple Output (MIMO) encoding and precoding for beamforming.

The baseband processor 1503 may include a modem processor (e.g., Digital Signal Processor (DSP)) that performs the digital baseband signal processing and a protocol stack processor (e.g., Central Processing Unit (CPU) or Micro Processing Unit (MPU)) that performs the control-plane processing. In this case, the protocol stack processor performing the control-plane processing may be integrated with an application processor 1504 described later.

The application processor 1504 may also be referred to as a CPU, an MPU, a microprocessor, or a processor core. The application processor 1504 may include a plurality of processors (processor cores). The application processor 1504 loads a system software program (Operating System (OS)) and various application programs (e.g., a voice call application, a web browser, a mailer, a camera operation application, a music player application) from a memory 1506 or from another memory (not shown) and executes these programs, thereby providing various functions of the UE 1.

In some implementations, as represented by the dashed line (1505) in FIG. 15, the baseband processor 1503 and the application processor 1504 may be integrated on a single chip. In other words, the baseband processor 1503 and the application processor 1504 may be implemented in a single System on Chip (SoC) device 1505. A SoC device may be referred to as a system Large Scale Integration (LSI) or a chipset.

The memory 1506 is a volatile memory or a non-volatile memory, or a combination thereof. The memory 1506 may include a plurality of physically independent memory devices. The volatile memory is, for example, Static Random Access Memory (SRAM), Dynamic RAM (DRAM), or a combination thereof. The non-volatile memory may be a Mask Read Only Memory (MROM), an Electrically Erasable Programmable ROM (EEPROM), a flash memory, a hard disk drive, or any combination thereof. The memory 1506 may include, for example, an external memory device that can be accessed by the baseband processor 1503, the application processor 1504, or the SoC 1505. The memory 1506 may include an internal memory device that is integrated into the baseband processor 1503, the application processor 1504, or the SoC 1505. Further, the memory 1506 may include a memory in a Universal Integrated Circuit Card (UICC).

The memory 1506 may store one or more software modules (computer programs) 1507 including instructions and data for processing by the UE 1 described in the above example embodiments. In some implementations, the baseband processor 1503 or the application processor 1504 may load the software module(s) 1507 from the memory 1506 and execute the loaded software module(s) 1507, thereby performing the processing of the UE 1 described in the above example embodiments with reference to the drawings.

The control-plane processing and operations performed by the UE 1 described in the above example embodiments can be achieved by elements other than the RF transceiver 1501 and the antenna array 1502, i.e., achieved by the memory 1506, which stores the software module(s) 1507, and one or both of the baseband processor 1503 and the application processor 1504.

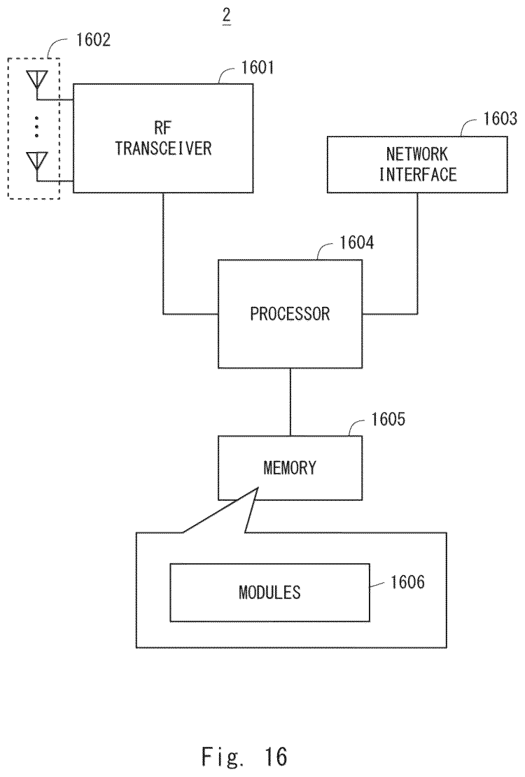

FIG. 16 is a block diagram showing an example configuration of the RAN node 2 according to the example embodiments described above. Referring to FIG. 16, the RAN node 2 includes a Radio Frequency transceiver 1601, a network interface 1603, a processor 1604, and a memory 1605. The RF transceiver 1601 performs analog RF signal processing to communicate with UEs 1 and other UEs. The RF transceiver 1601 may include a plurality of transceivers. The RF transceiver 1601 is coupled to an antenna array 1602 and the processor 1604. The RF transceiver 1601 receives modulated symbol data from the processor 1604, generates a transmission RF signal, and supplies the transmission RF signal to the antenna array 1602. The RF transceiver 1601 generates a baseband reception signal based on a reception RF signal received by the antenna array 1602 and supplies the baseband reception signal to the processor 1604. The RF transceiver 1601 may include an analog beamformer circuit for beamforming. The analog beamformer circuit includes, for example, a plurality of phase shifters and a plurality of power amplifiers.

The network interface 1603 is used to communicate with network nodes (e.g., other RAN nodes, and control and transfer nodes in the core network). The network interface 1603 may include, for example, a Network Interface Card (NIC) that complies with the IEEE 802.3 series.

The processor 1604 performs digital baseband signal processing (data-plane processing) and control-plane processing for wireless communication. The processor 1604 may include a plurality of processors. For example, the processor 1604 may include a modem processor (e.g., Digital Signal Processor (DSP)) for performing the digital baseband signal processing and a protocol stack processor (e.g., Central Processing Unit (CPU) or Micro Processing Unit (MPU)) for performing the control-plane processing. The processor 1604 may include a digital beamformer module for beamforming. The digital beamformer module may include a Multiple Input Multiple Output (MIMO) encoder and precoder.

The memory 1605 consists of a combination of a volatile memory and a non-volatile memory. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 1605 may include a storage located away from the processor 1604. In this case, the processor 1604 may access the memory 1605 through the network interface 1603 or another I/O interface.

The memory 1605 may store one or more software modules (computer programs) 1606 including instructions and data for performing processing by the RAN node 2 described in the above example embodiments. In some implementations, the processor 1604 may be configured to load and execute the software module(s) 1606 from the memory 1605, thereby performing the processing of the RAN node 2 described in the above example embodiments.

If the RAN node 2 is a Central Unit (CU) (e.g., gNB-CU) or a CU Control Plane Unit (CU-CP) (e.g., gNB-CU-CP), the RAN node 2 does not need to include the RF transceiver 1601 (and antenna array 1602).

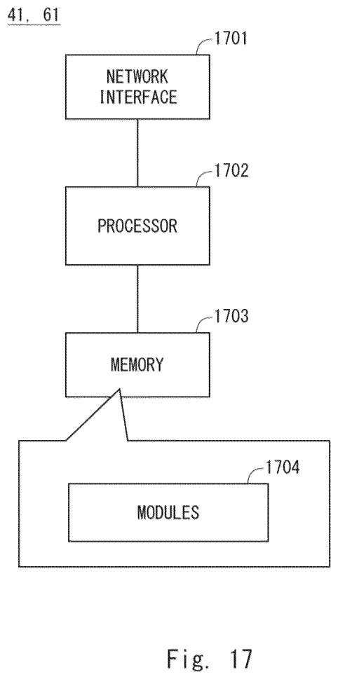

FIG. 17 shows an example configuration of the AMF 41. Other core network nodes in the 5GC 40 and the V2X application server 61 may also have a configuration similar to that shown in FIG. 17. For example, the network interface 1701 is used to communicate with other network functions (NFs) or nodes. For example, the network interface 1701 may include a network interface card (NIC) that is compliant with the IEEE 802.3 series.

The processor 1702 may be, for example, a microprocessor, a Micro Processing Unit (MPU), or a Central Processing Unit (CPU). The processor 1702 may include a plurality of processors.

The memory 1703 consists of a combination of a volatile memory and a non-volatile memory. The memory 1703 may include multiple physically independent memory devices. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 1703 may include a storage located away from the processor 1702. In this case, the processor 1702 may access the memory 1703 through the network interface 1701 or another I/O interface.

The memory 1703 may store one or more software modules (computer programs) 1704 including instructions and data for performing processing by the AMF 41 described in the above example embodiments. In some implementations, the processor 1702 may be configured to load and execute the software module(s) 1704 from the memory 1703, thereby performing the processing of the AMF 41 described in the above example embodiments.

As described using FIGS. 15, 16, and 17, each of the processors of the UE 1, the RAN node 2, the core network nodes such as the AMF 41, and the V2X application server 61 according to the example embodiments described above can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The example embodiments described above are merely examples of applications of the technical ideas of the inventor. These technical ideas are not limited to the above-described example embodiments, and various modifications may be made thereto.

For example, the whole or part of the example embodiments disclosed above can be described as, but not limited to, the following supplementary notes.

### (Supplementary Note 1)

A radio terminal comprising:
at least one radio transceiver; and
at least one processor coupled to the at least one radio transceiver and configured to:
   use, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
   generate one or both of a buffer status report and traffic pattern information, considering a transmission status of transmission on the second sidelink carrier; and
   transmit one or both of the buffer status report and the traffic pattern information to the radio access network node.

### (Supplementary Note 2)

The radio terminal according to Supplementary Note 1, wherein the at least one processor is configured to generate the buffer status report by reducing a total volume of data buffered in the radio terminal for transmission to the peer radio terminal, based on the transmission status of transmission on the second sidelink carrier.

### (Supplementary Note 3)

The radio terminal according to Supplementary Note 1 or 2, wherein the at least one processor is configured to generate the buffer status report by subtracting an estimated volume of data that can be transmitted on the second sidelink carrier from a total volume of data buffered in the radio terminal for transmission to the peer radio terminal.

### (Supplementary Note 4)

The radio terminal according to any one of Supplementary Notes 1 to 3, wherein the at least one processor is configured to generate the traffic pattern information in a manner that indicates an estimated traffic pattern of transmission on the first sidelink carrier, except for an estimated traffic pattern of transmission on the second sidelink carrier.

### (Supplementary Note 5)

The radio terminal according to any one of Supplementary Notes 1 to 4, wherein the traffic pattern information includes one or both of an estimated data arrival periodicity and a maximum transport block size.

### (Supplementary Note 6)

The radio terminal according to any one of Supplementary Notes 1 to 5, wherein the at least one processor is configured to use a Channel Busy Ratio (CBR) of the second sidelink carrier or a Sidelink Reference Signal Received Power (SL-RSRP) of the second sidelink carrier to generate one or both of the buffer status report and the traffic pattern information.

### (Supplementary Note 7)

The radio terminal according to any one of Supplementary Notes 1 to 6, wherein the first sidelink carrier belongs to a licensed spectrum of the radio access network node, and the second sidelink carrier belongs to an unlicensed spectrum.

### (Supplementary Note 8)

The radio terminal according to any one of Supplementary Notes 1 to 7, wherein the transmission status of transmission on the second sidelink carrier is a transmission status estimated by the radio terminal.

### (Supplementary Note 9)

The radio terminal according to any one of Supplementary Notes 1 to 8, wherein
the buffer status report is transmitted to the radio access network node to obtain a dynamic grant for the first sidelink carrier, and
the traffic pattern information is transmitted to the radio access network node to obtain a configured grant for the first sidelink carrier.

### (Supplementary Note 10)

A method performed by a radio terminal, the method comprising:
using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
generating one or both of a buffer status report and traffic pattern information, considering a transmission status of transmission on the second sidelink carrier; and
transmitting one or both of the buffer status report and the traffic pattern information to the radio access network node.

### (Supplementary Note 11)

A non-transitory computer readable medium storing a program for causing a computer to perform a method for a radio terminal, the method comprising:
using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
generating one or both of a buffer status report and traffic pattern information, considering a transmission status of transmission on the second sidelink carrier; and
transmitting one or both of the buffer status report and the traffic pattern information to the radio access network node.

### (Supplementary Note 12)

A radio terminal comprising:
at least one radio transceiver; and
at least one processor coupled to the at least one radio transceiver and configured to:
   use, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
   transmit one or both of a buffer status report and traffic pattern information to a radio access network node; and
   transmit assistance information to the radio access network node, the assistance information being used by the radio access network node to obtain a transmission status of transmission on the second sidelink carrier.

### (Supplementary Note 13)

The radio terminal according to Supplementary Note 12, wherein the assistance information indicates one or any combination of: a size of a transmission resource pool of the second sidelink carrier; a bandwidth of the transmission resource pool; a Channel Busy Ratio (CBR) of the second sidelink carrier; a Sidelink Reference Signal Received Power (SL-RSRP) of the second sidelink carrier; and Sidelink Channel State Information (SL-CSI) of the second sidelink carrier.

### (Supplementary Note 14)

The radio terminal according to Supplementary Note 12 or 13, wherein the at least one processor is configured to transmit the assistance information using a Radio Resource Control (RRC) message.

### (Supplementary Note 15)

The radio terminal according to Supplementary Note 14, wherein the RRC message is a MeasurementReport message, a UEassistanceinformation message, or a SIdelinkUEinformationNR message.

### (Supplementary Note 16)

The radio terminal according to any one of Supplementary Notes 12 to 15, wherein the first sidelink carrier belongs to a licensed spectrum of the radio access network node, and the second sidelink carrier belongs to an unlicensed spectrum.

### (Supplementary Note 17)

The radio terminal according to any one of Supplementary Notes 12 to 16, wherein the assistance information is used by the radio access network node to estimate the transmission status of transmission on the second sidelink carrier.

### (Supplementary Note 18)

The radio terminal according to any one of Supplementary Notes 12 to 17, wherein
the buffer status report is transmitted to the radio access network node to obtain a dynamic grant for the first sidelink carrier, and
the traffic pattern information is transmitted to the radio access network node to obtain a configured grant for the first sidelink carrier.

### (Supplementary Note 19)

A method performed by a radio terminal, the method comprising:
using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
transmitting one or both of a buffer status report and traffic pattern information to a radio access network node; and
transmitting assistance information to the radio access network node, the assistance information being used by the radio access network node to obtain a transmission status of transmission on the second sidelink carrier.

### (Supplementary Note 20)

A non-transitory computer readable medium storing a program for causing a computer to perform a method for a radio terminal, the method comprising:
using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
transmitting one or both of a buffer status report and traffic pattern information to a radio access network node; and
transmitting assistance information to the radio access network node, the assistance information being used by the radio access network node to obtain a transmission status of transmission on the second sidelink carrier.

### (Supplementary Note 21)

A radio access network node comprising:
at least one memory; and
at least one processor coupled to the at least one memory and configured to:
   receive from a radio terminal one or both of a buffer status report and traffic pattern information regarding a first sidelink carrier to which a first resource allocation mode is applied in which resources are allocated by the radio access network node;
   receive, from the radio terminal, assistance information regarding a second sidelink carrier to which a second resource allocation mode is applied in which the radio terminal autonomously selects resources;
   generate one or both of a dynamic grant and a configured grant, considering a transmission status of transmission on the second sidelink carrier obtained based on the assistance information; and
   transmit one or both of the generated dynamic grant and the generated configured grant to the radio terminal.

### (Supplementary Note 22)

The radio access network node according to Supplementary Note 21, wherein the at least one processor is configured to generate the dynamic grant by reducing a total volume of data indicated in the buffer status report as being buffered in the radio terminal for sidelink transmission to a peer radio terminal, based on an estimated transmission status of transmission on the second sidelink carrier.

### (Supplementary Note 23)

The radio access network node according to Supplementary Note 21 or 22, wherein the at least one processor is configured to generate the dynamic grant by subtracting an estimated volume of data that can be transmitted on the second sidelink carrier from a total volume of data indicated in the buffer status report as being buffered in the radio terminal for sidelink transmission to a peer radio terminal.

### (Supplementary Note 24)

The radio access network node according to any one of Supplementary Notes 21 to 23, wherein the at least one processor is configured to generate the configured grant by removing an estimated traffic pattern of transmission on the second sidelink carrier from a traffic pattern indicated in the traffic pattern information.

### (Supplementary Note 25)

The radio access network node according to any one of Supplementary Notes 21 to 24, wherein the traffic pattern information includes one or both of an estimated data arrival periodicity and a maximum transport block size.

### (Supplementary Note 26)

The radio access network node according to any one of Supplementary Notes 21 to 25, wherein the assistance information indicates one or any combination of: a size of a transmission resource pool of the second sidelink carrier; a bandwidth of the transmission resource pool; a Channel Busy Ratio (CBR) of the second sidelink carrier; a Sidelink Reference Signal Received Power (SL-RSRP) of the second sidelink carrier; and Sidelink Channel State Information (SL-CSI) of the second sidelink carrier.

### (Supplementary Note 27)

The radio access network node according to any one of Supplementary Notes 21 to 26, wherein the at least one processor is configured to receive the assistance information using a Radio Resource Control (RRC) message.

### (Supplementary Note 28)

The radio access network node according to Supplementary Note 27, wherein the RRC message is a MeasurementReport message, a UEassistanceinformation message, or a SIdelinkUEinformationNR message.

### (Supplementary Note 29)

The radio access network node according to any one of Supplementary Notes 21 to 28, wherein the first sidelink carrier belongs to a licensed spectrum of the radio access network node, and the second sidelink carrier belongs to an unlicensed spectrum.

### (Supplementary Note 30)

The radio access network node according to any one of Supplementary Notes 21 to 29, wherein the at least one processor is configured to estimate the transmission status of transmission on the second sidelink carrier based on the assistance information.

### (Supplementary Note 31)

The radio access network node according to any one of Supplementary Notes 21 to 30, wherein
the buffer status report is transmitted by the radio terminal to the radio access network node to obtain the dynamic grant for the first sidelink carrier, and
the traffic pattern information is transmitted by the radio terminal to the radio access network node to obtain the configured grant for the first sidelink carrier.

### (Supplementary Note 32)

A method performed by a radio access network node, the method comprising:
receiving from a radio terminal one or both of a buffer status report and traffic pattern information regarding a first sidelink carrier to which a first resource allocation mode is applied in which resources are allocated by the radio access network node;
receiving, from the radio terminal, assistance information regarding a second sidelink carrier to which a second resource allocation mode is applied in which the radio terminal autonomously selects resources;
generating one or both of a dynamic grant and a configured grant, considering a transmission status of transmission on the second sidelink carrier obtained based on the assistance information; and
transmitting one or both of the generated dynamic grant and the generated configured grant to the radio terminal.

### (Supplementary Note 33)

A non-transitory computer readable medium storing a program for causing a computer to perform a method for a radio access network node, the method comprising:
receiving from a radio terminal one or both of a buffer status report and traffic pattern information regarding a first sidelink carrier to which a first resource allocation mode is applied in which resources are allocated by the radio access network node;
receiving, from the radio terminal, assistance information regarding a second sidelink carrier to which a second resource allocation mode is applied in which the radio terminal autonomously selects resources;
generating one or both of a dynamic grant and a configured grant, considering a transmission status of transmission on the second sidelink carrier obtained based on the assistance information; and
transmitting one or both of the generated dynamic grant and the generated configured grant to the radio terminal.

### (Supplementary Note 34)

A radio terminal comprising:
at least one radio transceiver; and
at least one processor coupled to the at least one radio transceiver and configured to:
   use, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources; and
   if there is data to be transmitted and if resources of the second sidelink carrier are also available in a time slot of the first sidelink carrier for which a dynamic grant or a configured grant has been obtained, determine whether to transmit the data on the first sidelink carrier or the second sidelink carrier according to a predetermined rule.

### (Supplementary Note 35)

The radio terminal according to Supplementary Note 34, wherein the at least one processor is configured to receive from the radio access network node a signaling indicating the predetermined rule or one or more parameters for defining the predetermined rule.

### (Supplementary Note 36)

The radio terminal according to Supplementary Note 34 or 35, wherein when the radio transceiver is capable of simultaneous sidelink transmission on the first sidelink carrier and sidelink transmission on the second sidelink carrier in a time domain, the predetermined rule includes preferentially transmitting the data on the first sidelink carrier.

### (Supplementary Note 37)

The radio terminal according to Supplementary Note 36, wherein the predetermined rule includes, if there is excess data that cannot be included in a first transport block to be transmitted on the first sidelink carrier in the time slot based on the dynamic grant or the configured grant, including the excess data in a second transport block to be transmitted on the second sidelink carrier.

### (Supplementary Note 38)

The radio terminal according to Supplementary Note 34 or 35, wherein, when the radio transceiver is capable of simultaneous sidelink transmission on the first sidelink carrier and sidelink transmission on the second sidelink carrier in a time domain, the predetermined rule includes, if a difference between a Channel Busy Ratio (CBR) of the first sidelink carrier and a CBR of the second sidelink carrier exceeds a threshold value, selecting one of the two carriers having the lower CBR, otherwise selecting both of the two carriers.

### (Supplementary Note 39)

The radio terminal according to Supplementary Note 34 or 35, wherein, when the radio transceiver is capable of simultaneous sidelink transmission on the first sidelink carrier and sidelink transmission on the second sidelink carrier in a time domain, the predetermined rule includes, if a difference between a Sidelink Reference Signal Received Power (SL-RSRP) of the first sidelink carrier and an SL-RSRP of the second sidelink carrier exceeds a threshold value, selecting one of the two carriers having the better SL-RSRP, otherwise selecting both of the two carriers.

### (Supplementary Note 40)

The radio terminal according to Supplementary Note 34 or 35, wherein, when the radio transceiver is capable of simultaneous sidelink transmission on the first sidelink carrier and sidelink transmission on the second sidelink carrier in a time domain, the predetermined rule includes selecting one or both of the first sidelink carrier and the second sidelink carrier whose Channel Busy Ratio (CBR) is lower than a threshold value.

### (Supplementary Note 41)

The radio terminal according to Supplementary Note 34 or 35, wherein, when the radio transceiver is capable of simultaneous sidelink transmission on the first sidelink carrier and sidelink transmission on the second sidelink carrier in a time domain, the predetermined rule includes selecting one or both of the first sidelink carrier and the second sidelink carrier whose Sidelink Reference Signal Received Power (SL-RSRP) is better than a threshold value.

### (Supplementary Note 42)

The radio terminal according to Supplementary Note 34 or 35, wherein, when the radio transceiver is not capable of simultaneous sidelink transmission on the first sidelink carrier and sidelink transmission on the second sidelink carrier in a time domain, the predetermined rule includes preferentially transmitting the data on the first sidelink carrier.

### (Supplementary Note 43)

The radio terminal according to Supplementary Note 34 or 35, wherein, when the radio transceiver is not capable of simultaneous sidelink transmission on the first sidelink carrier and sidelink transmission on the second sidelink carrier in a time domain, the predetermined rule includes selecting the second sidelink carrier when a Channel Busy Ratio (CBR) of the second sidelink carrier is lower than a CBR of the first sidelink carrier by more than a threshold value, otherwise selecting the first sidelink carrier.

### (Supplementary Note 44)

The radio terminal according to Supplementary Note 34 or 35, wherein when the radio transceiver is not capable of simultaneous sidelink transmission on the first sidelink carrier and sidelink transmission on the second sidelink carrier in a time domain, the predetermined rule includes selecting the second sidelink carrier when a Sidelink Reference Signal Received Power (SL-RSRP) of the second sidelink carrier is better than an SL-RSRP of the first sidelink carrier by more than a threshold value, otherwise selecting the first sidelink carrier.

### (Supplementary Note 45)

The radio terminal according to Supplementary Note 34 or 35, wherein when the radio transceiver is not capable of simultaneous sidelink transmission on the first sidelink carrier and sidelink transmission on the second sidelink carrier in a time domain, the predetermined rule includes selecting one of the first sidelink carrier and the second sidelink carrier whose Channel Busy Ratio (CBR) is lower than that of the other.

### (Supplementary Note 46)

The radio terminal according to Supplementary Note 34 or 35, wherein when the radio transceiver is not capable of simultaneous sidelink transmission on the first sidelink carrier and sidelink transmission on the second sidelink carrier in a time domain, the predetermined rule includes selecting one of the first sidelink carrier and the second sidelink carrier whose Sidelink Reference Signal Received Power (SL-RSRP) is better than that of the other.

### (Supplementary Note 47)

A method performed by a radio terminal, the method comprising:
using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources; and
if there is data to be transmitted and if resources of the second sidelink carrier are also available in a time slot of the first sidelink carrier for which a dynamic grant or a configured grant has been obtained, determining whether to transmit the data on the first sidelink carrier or the second sidelink carrier according to a predetermined rule.

### (Supplementary Note 48)

A non-transitory computer readable medium storing a program for causing a computer to perform a method for a radio terminal, the method comprising:
using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources; and
if there is data to be transmitted and if resources of the second sidelink carrier are also available in a time slot of the first sidelink carrier for which a dynamic grant or a configured grant has been obtained, determining whether to transmit the data on the first sidelink carrier or the second sidelink carrier according to a predetermined rule.

This application is based upon and claims the benefit of priority from Japanese Patent Application No. 2022-038088, filed on Mar. 11, 2022, the disclosure of which is incorporated herein in its entirety by reference.

### REFERENCE SIGNS LIST

1A, 1B UE
2 RAN node
21 Cell
41 AMF
44 PCF
61 V2X application server
103 Inter-UE direct interface
1503 Baseband processor
1504 Application processor
1506 Memory
1507 Modules
1604 Processor
1605 Memory
1606 Modules
1702 Processor
1703 Memory
1704 Modules

What is claimed is:

1. A radio terminal comprising:
at least one radio transceiver; and
at least one processor coupled to the at least one radio transceiver and configured to:
use, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
generate one or both of a buffer status report and traffic pattern information, considering a transmission status of transmission on the second sidelink carrier; and
transmit one or both of the buffer status report and the traffic pattern information to the radio access network node.

2. The radio terminal according to claim 1, wherein the at least one processor is configured to generate the buffer status report by reducing a total volume of data buffered in the radio terminal for transmission to the peer radio terminal, based on the transmission status of transmission on the second sidelink carrier.

3. The radio terminal according to claim 1, wherein the at least one processor is configured to generate the buffer status report by subtracting an estimated volume of data that can be transmitted on the second sidelink carrier from a total volume of data buffered in the radio terminal for transmission to the peer radio terminal.

4. The radio terminal according to claim 1, wherein the at least one processor is configured to generate the traffic pattern information in a manner that indicates an estimated traffic pattern of transmission on the first sidelink carrier, except for an estimated traffic pattern of transmission on the second sidelink carrier.

5. The radio terminal according to claim 1, wherein the traffic pattern information includes one or both of an estimated data arrival periodicity and a maximum transport block size.

6. The radio terminal according to claim 1, wherein the at least one processor is configured to use a Channel Busy Ratio (CBR) of the second sidelink carrier or a Sidelink Reference Signal Received Power (SL-RSRP) of the second sidelink carrier to generate one or both of the buffer status report and the traffic pattern information.

7. The radio terminal according to claim 1, wherein the first sidelink carrier belongs to a licensed spectrum of the radio access network node, and the second sidelink carrier belongs to an unlicensed spectrum.

8. The radio terminal according to claim 1, wherein the transmission status of transmission on the second sidelink carrier is a transmission status estimated by the radio terminal.

9. The radio terminal according to claim 1, wherein
the buffer status report is transmitted to the radio access network node to obtain a dynamic grant for the first sidelink carrier, and
the traffic pattern information is transmitted to the radio access network node to obtain a configured grant for the first sidelink carrier.

10. A method performed by a radio terminal, the method comprising:
using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
generating one or both of a buffer status report and traffic pattern information, considering a transmission status of transmission on the second sidelink carrier; and
transmitting one or both of the buffer status report and the traffic pattern information to the radio access network node.

11. A non-transitory computer readable medium storing a program for causing a computer to perform a method for a radio terminal, the method comprising:
using, for sidelink communication with a peer radio terminal, a first sidelink carrier to which a first resource allocation mode is applied in which resources are allocated by a radio access network node, and a second sidelink carrier to which a second resource allocation mode is applied in which the radio terminal autonomously selects resources;
generating one or both of a buffer status report and traffic pattern information, considering a transmission status of transmission on the second sidelink carrier; and
transmitting one or both of the buffer status report and the traffic pattern information to the radio access network node.

12-48. (canceled)

49. The method according to claim 10, wherein the generating comprises generating the buffer status report by reducing a total volume of data buffered in the radio terminal for transmission to the peer radio terminal, based on the transmission status of transmission on the second sidelink carrier.

50. The method according to claim 10, wherein the generating comprises generating the buffer status report by subtracting an estimated volume of data that can be transmitted on the second sidelink carrier from a total volume of data buffered in the radio terminal for transmission to the peer radio terminal.

51. The method according to claim 10, wherein the generating comprises generating the traffic pattern information in a manner that indicates an estimated traffic pattern of transmission on the first sidelink carrier, except for an estimated traffic pattern of transmission on the second sidelink carrier.

52. The method according to claim 10, wherein the traffic pattern information includes one or both of an estimated data arrival periodicity and a maximum transport block size.

53. The method according to claim 10, wherein the generating comprises using a Channel Busy Ratio (CBR) of the second sidelink carrier or a Sidelink Reference Signal Received Power (SL-RSRP) of the second sidelink carrier to generate one or both of the buffer status report and the traffic pattern information.
